(19) United States
(12) Patent Application Publication
(10) Pub. No.: US 2024/0389589 A1
(43) Pub. Date: Nov. 28, 2024

(54) CORROSION INHIBITORS FOR NITROGEN INHIBITOR FORMULATION

(71) Applicant: Verdesian Life Sciences U.S., LLC, Cary, NC (US)

(72) Inventors: Janice Paletta, Durham, NC (US); Kuide Qin, Chapel Hill, NC (US); Gary Orr, Pittsboro, NC (US)

(21) Appl. No.: 18/690,931

(22) PCT Filed: Aug. 29, 2022
(86) PCT No.: PCT/US2022/041857

§ 371 Date: Mar. 11, 2024

Related U.S. Application Data
(60) Provisional application No. 63/243,405, filed on Sep. 13, 2021.

(51) Int. Cl. A01N 43/40; A01N 25/22; A01P 21/00

(52) U.S. Cl. CPC A01N 43/40; A01N 25/22; A01P 21/00

(57) ABSTRACT

The presently disclosed subject matter is directed to noncorrosive nitrapyin formulations and preparation thereof finding particular utility in agricultural uses, e.g., directly applied to soil, or in combination with fertilizers to increase nutrient uptake and to inhibit nitrification and urease hydrolysis. More particularly, the subject matter is directed to nitrapyrin complexes formulated with amine-based corrosion inhibitors that exhibit reduced corrosion behavior compared to nitrapyrin-containing formulations that do not contain amine-based corrosion inhibitors. Uses of such noncorrosive nitrapyin formulations are also disclosed.

### FIELD

The presently disclosed subject matter relates to liquid formulation compositions comprising the nitrification inhibitor nitrapyrin complexed to a polyanion in the presence of an amine-based corrosion inhibitor finding particular utility in agricultural uses to increase uptake and to inhibit nitrification.

### BACKGROUND

Nitrogen fertilizer added to the soil is readily transformed through a number of biological and chemical processes, including nitrification, leaching, and evaporation. Many transformation processes are undesirable because they reduce the level of nitrogen available for uptake by the targeted plant. The decrease in available nitrogen requires the addition of more nitrogen rich fertilizer to compensate for the loss of agriculturally active nitrogen available to the plants. Nitrification is the process by which certain widely occurring soil bacteria metabolize the ammonium form of nitrogen in the soil transforming the nitrogen into nitrite and nitrate forms, which are more susceptible to nitrogen loss through leaching or volatilization via denitrification. These concerns require improved management of nitrogen for economic efficiency and protection of the environment.

Nitrogen nutrient use efficiency enhancing compounds attempt to reduce nitrification. These so-called nitrification inhibitors have been developed to inhibit nitrogen loss due to nitrification. One class of nitrification inhibitors in use is composed of various chlorinated compounds related to pyridine, as taught by Goring in U.S. Pat. No. 3,135,594 (incorporated herein in its entirety by reference). Nitrapyrin is an example of a nitrification inhibitor.

Current formulations consist of nitrapyrin dissolved in large volumes of volatile, flammable, toxicologically problematic, environmentally problematic, and/or highly odoriferous aromatic solvents (e.g., toluene, xylenes, etc.). For every unit weight of nitrapyrin delivered to the field, more than 3-4 unit weights of such solvents are also delivered to the same soil. The relatively low concentration of active ingredient contributes to increased shipping costs, increased difficulty of handling, and reduced efficiency. Furthermore, once nitrapyrin has been employed, it suffers from significant losses to the atmosphere, resulting in undesirable environmental effects, loss of efficacy of product by way of potency loss, and offensive odors.

Often the nitrapyrin formulations are first mixed into a form of liquid nitrogen fertilizer solution (e.g., UAN and anhydrous ammonia) or coated onto the granular nitrogen fertilizer (e.g., urea). When the formulated nitrapyrin composition is in contact with water, either through the liquid fertilizer solution or moisture from the air, the corrosivity of the nitrapyrin formulation will cause failure of the equipment used to apply the nitrapyrin incorporated fertilizer products. The corrosion is typically observed in the metal components of the fertilizer application equipment where the components are in contact with the nitrapyrin formulation.

The equipment failure causes downtime during the limited fertilizer application season and significant economic losses.

Therefore, it would be highly desirable to find a way to depress nitrapyrin volatilization without resorting to costly techniques and using formulations that are more economical, less toxic, less corrosive, and less harmful to the environment.

### BRIEF SUMMARY

In one aspect, the subject matter described herein is directed to a noncorrosive nitrapyrin formulation containing a nitrapyrin complex comprising nitrapyrin complexed with a polyanion, an amine-based corrosion inhibitor, and an organic solvent. The polyanion can be a polyanionic polymer or a non-polymeric polyanion.

In some embodiments, the amine-based corrosion inhibitor is selected from a neutralizing amine, a film-forming amine, or a combination thereof.

In some embodiments, the noncorrosive nitrapyrin formulation can further comprise a surface active agent, an antifoam agent, a dispersant, or a combination thereof.

In some embodiments, the disclosed noncorrosive nitrapyrin formulations exhibit decreased corrosive behavior towards materials (e.g., metal-based materials) found in agricultural equipment.

In one aspect, the subject matter described herein is directed to a composition comprising an agricultural product and a noncorrosive formulation as disclosed herein.

In one aspect, the subject matter described herein is directed to methods of increasing plant growth, yields, and health, by contacting a noncorrosive nitrapyrin formulation with the plant or soil in the area of the plant.

In one aspect, the subject matter described herein is directed to methods of decreasing nitrification and/or reducing atmospheric ammonia.

In one aspect, the subject matter described herein is directed to methods of preparing the disclosed noncorrosive nitrapyrin formulation.

These and other aspects are fully described below.

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

Advantageously, the compositions, formulations and methods described herein have been shown to provide desirable properties for the use of nitrapyrin in agriculture by formulating nitrapyrin with polyanions that are capable of forming complexes with nitrapyrin, and one or more of polar solvents that can dissolve the formed nitrapyrin complexes. Other aspects described herein include compositions, formulations, and methods employing nitrapyrin, which can be formulated neat or one or more organic solvents to yield formulations with desirable properties. In particular, such compositions and formulations include the disclosed complexes with an amine-based corrosion inhibitor. Desirable properties exhibited by these compositions and formulations include, but are not limited to: low cost, higher actives content relative to marketed products, ease of preparation, ease of handling, high solubility in certain solvents, excellent environmental and toxicology profiles, and reduced level of corrosion towards materials found in agricultural application equipment (e.g., metal-based materials). As disclosed herein, among other properties, the nitrapyrin-organic acid ionic mixtures have significantly lower vapor pressure, thereby reducing volatilization; increased solubility, thereby providing compositions with high loading and/or concentration; and increased stability (i.e., chemically and/or thermally) when formulated in an environment with reduced water content.

Heretofore, methods found in the art for reducing volatility of materials involving pyridine derivatives involved an approach extremely different from the methods disclosed herein. For example, the use of poly(4-vinylpyridine) sulfur trioxide complex is known to the art of sulfonation chemistry, wherein the volatility of sulfur trioxide is controlled by formation of a complex with poly(vinylpyridine). In this example, the pyridine derivative part of the molecule is the non-volatile portion, whereas the sulfur trioxide is the volatile portion. By contrast, the distinctly different approach as described herein utilizes nitraprin complexes with polyanions as a non-volatile component and a pyridine derivative, such as nitrapyrin as a volatile component. Unexpectedly, formulations containing nitrapyrin, a nitrapyrin-containing agent, and/or a nitrapyrin complex in combination with an amide-based corrosion inhibitor exhibited a reduced level of corrosion towards materials used in agricultural equipment, particularly metal-based materials, compared to other nitrapyrin-containing formulations.

### I. Definitions

As used herein, the term “complex” or “complex substance” refers to chelates and coordination complexes of nitrapyrin, wherein nitrapyrin associates with functional groups of polyanion(s) in a covalent (i.e., bond forming) or non-covalent (e.g., ionic, hydrogen bonding, or the like) manner. In a complex, a central moiety or ion (e.g., nitrapyrin) associates with a surrounding array of bound molecules or ions known as ligands or complexing agents (e.g., polyanion(s)). The central moiety binds to or associates with several donor atoms of the ligand, wherein the donor atoms can be the same type of atom or can be a different type of atom. Ligands or complexing agents bound to the central moiety through several of the ligand's donor atoms forming multiple bonds (i.e., 2, 3, 4 or even 6 bonds) are referred to as polydentate ligands. Complexes with polydentate ligands are called chelates. Typically, complexes of central moieties with ligands are increasingly more soluble than the central moiety by itself because the ligands that surround the central moiety do not dissociate from the central moiety once in solution and solvate the central moiety thereby promoting its solubility.

As used herein, the term “salt” refers to chemical compounds consisting of an assembly of cations and anions. Salts are composed of related numbers of cations (positively charged ions) and anions (negative ions) so that the product is electrically neutral (without a net charge). Many ionic compounds exhibit significant solubility in water or other polar solvents. The solubility is dependent on how well each ion interacts with the solvent.

As used herein, the term “alkyl group” refers to a saturated hydrocarbon radical containing 1-22, 1 to 8, 1 to 6, 1 to 4, or 5 to 8 carbons and/or any ranges within 1-22 carbons. An alkyl group is structurally similar to a noncyclic alkane compound modified by the removal of one hydrogen from the noncyclic alkane and the substitution therefore of a non-hydrogen group or radical. Alkyl group radicals can be branched or unbranched. Lower alkyl group radicals have 1 to 4 carbon atoms. Higher alkyl group radicals have 5 to 22 carbon atoms. Examples of alkyl, lower alkyl, and higher alkyl group radicals include, but are not limited to, methyl, ethyl, n-propyl, iso-propyl, n-butyl, sec-butyl, t-butyl, amyl, t-amyl, n-pentyl, n-hexyl, i-octyl and like radicals.

As used herein, the term “substituted” refers to a moiety (such as heteroaryl, aryl, alkyl, and/or alkenyl) wherein the moiety is bonded to one or more additional organic or inorganic substituent radicals. In some embodiments, the substituted moiety comprises 1, 2, 3, 4, or 5 additional substituent groups or radicals. Suitable organic and inorganic substituent radicals include, but are not limited to, hydroxyl, cycloalkyl, aryl, substituted aryl, heteroaryl, heterocyclic ring, substituted heterocyclic ring, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkylsulfonyl, alkylsulfinyl, thioalkyl, alkoxy, substituted alkoxy or haloalkoxy radicals, wherein the terms are defined herein. Unless otherwise indicated herein, the organic substituents can comprise from 1 to 4 or from 5 to 8 carbon atoms. When a substituted moiety is bonded thereon with more than one substituent radical, then the substituent radicals may be the same or different.

As used herein, the term “unsubstituted” refers to a moiety (such as heteroaryl, aryl, alkenyl, and/or alkyl) that is not bonded to one or more additional organic or inorganic substituent radical as described above, meaning that such a moiety is only substituted with hydrogens.

As used herein, the term “chemical stability” refers to the resistance of a substance to structurally change when exposed to an external action such as air (which can lead to oxidation), light (e.g., sunlight), moisture/humidity (from water), heat (from the sun), and/or chemical agents. Exemplary chemical agents include, but are not limited to, any organic or inorganic substance that can degrade the structural integrity of the compound of interest (e.g., the disclosed nitrapyin-polyanionic polymer complex). Chemical stability is also used to evaluate the stability of a formulation when determining its shelf-life. Components of a formulation exhibit a certain chemical stability when exposed to storage conditions such as air (which can lead to oxidation), light (e.g., sunlight), moisture/humidity (from water), heat (from the sun), and/or chemical agents.

As used herein, the term “thermal stability” refers to the stability of a substance when exposed to a thermal stimuli over a given period of time. Examples of thermal stimuli include, but are not limited to, heat generated from an electrical source and/or heat generated from the sun.

As used herein, the term “soil” is to be understood as a natural body comprised of living (e.g., microorganisms (such as bacteria and fungi), animals and plants) and non-living matter (e.g., minerals and organic matter (e.g., organic compounds in varying degrees of decomposition), liquid, and gases) that occurs on the land surface and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

As used herein, the term “fertilizer” is to be understood as chemical compounds applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed plant/animal matter) and b) inorganic fertilizers (composed of chemicals and minerals). Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal and seaweed extracts. Further examples are enzymatically digested proteins, fish meal, and feather meal. The decomposing crop residue from prior years is another source of fertility. In addition, naturally occurring minerals such as mine rock phosphate, sulfate of potash and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

As used herein, the term “manure” is organic matter used as organic fertilizer in agriculture. Depending on its structure, manure can be divided into liquid manure, semi-liquid manure, stable or solid manure, and straw manure. Depending on its origin, manure can be divided into manure derived from animals or plants. Common forms of animal manure include feces, urine, farm slurry (liquid manure), or farmyard manure (FYM), whereas FYM also contains a certain amount of plant material (typically straw), which may have been used as bedding for animals. Animals from which manure can be used comprise horses, cattle, pigs, sheep, chickens, turkeys, rabbits, and guano from seabirds and bats. The application rates of animal manure when used as fertilizer highly depends on the origin (type of animals). Plant manures may derive from any kind of plant whereas the plant may also be grown explicitly for the purpose of plowing them in (e.g., leguminous plants), thus improving the structure and fertility of the soil. Furthermore, plant matter used as manure may include the contents of the rumens of slaughtered ruminants, spent hops (left over from brewing beer) or seaweed.

As used herein, the term “seed” comprises seed of all types, such as, for example, corns, seeds, fruits, tubers, seedlings, and similar forms. The seed used can be seed of the useful plants mentioned above, but also the seed of transgenic plants or plants obtained by customary breeding methods.

As used herein, the term “reduce volatility” and the like refers to the volatility of the nitrapyrin salt as compared to that of the nitrapyrin-free base. The reduction in volatility can be quantified as described elsewhere herein.

As used herein, the term “organic solvent” refers to a non-aqueous solvent that solvates the nitrapyrin-organic acid ionic mixture to the degree as described elsewhere herein.

As used herein, the term “inhibit urease” and the like refers to the inhibition of the activity of urease. The inhibition can be quantified as described elsewhere herein.

As used herein, “N-Serve” refers to a composition comprising nitrapyrin at a concentration of 22.2% relative to the total solution. The solution comprises petroleum distillates as a solvent. The composition is formulated at a concentration of 2 lbs of active ingredient (nitrapyrin) per gallon.

As used herein, “Instinct II” refers a composition comprising nitrapyrin at a concentration of 16.95% relative to the total solution. The solution comprises petroleum distillates as a solvent. The composition is formulated at a concentration of 1.58 lbs of active ingredient (nitrapyrin) per gallon.

Additional definitions may follow below.

### II. Formulations

Nitrapyrin complexes with polyanionic species have been prepared with the purpose of employing these nitrapyrin complexes in noncorrosive nitrapyrin formulations. As mentioned above, these complexes can exhibit desirable properties such as a significantly lower vapor pressure, higher loading, and increased chemical/thermal stability, all of which generally contribute to an increased performance in the field.

Generally, nitrapyrin and/or the nitrapyrin complexes can be used neat or can include an organic solvent, an amine-based corrosion inhibitor, as well as other ingredients to form useful noncorrosive formulations. In some embodiments, the noncorrosive nitrapyrin formulation comprises a nitrapyrin complex, an amide-based corrosion inhibitor, and an organic solvent.

In some embodiments, the described formulations contain relatively little to no water. Formulations containing high amounts of water have shown rapid degradation of nitrapyrin and therefore the exposure of nitrapyrin to excessive amounts of water should be minimized. In some embodiments, the amount of water present in neat nitrapyrin complex (or nitrapyrin or nitrapyrin-containing agent) or in a formulation thereof containing organic solvent is less than about 10%, about 9%, about 8%, about 7%, about 6%, about 5%, about 4%, about 3%, about 2%, about 1%, or is less than 0.5% w/w based on the total weight of the formulation. In such formulations the chemical stability of the nitrapyrin complex is at least about 50%, about 60%, about 70%, about 80%, about 85%, about 90%, about 91%, about 92%, about 93%, about 94%, about 95%, about 96%, about 97%, about 98%, about 99%, or at least about 99.5%. See for example, Meikle et al. “The hydrolysis and photolysis rates of nitrapyrin in dilute aqueous solution” Arch. Environm. Contain. Toxicol. 7, 149-158 (1978).

A. Nitrapyrin Complexes with Polyanionic Species

Nitrapyrin is a nitrification inhibitor having the structure:

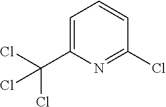 [SMILES: Clc1cccc(C(Cl)(Cl)Cl)n1]

It functions to inhibit nitrification within the soil bacteria, Nitrosomonas, which act on ammonia by oxidizing ammonium ions to nitrite and/or nitrate. Nitrification inhibition therefore reduces nitrogen emissions from soil.

Complexes of nitrapyrin include those formed with a suitable non-volatile polyanionic species. Polyanionic species include those polyanionic polymers disclosed in WO 2011/016898; WO 2015/031521; US2017/0183492; U.S. Pat. Nos. 10,336,659 and 10,059,636, each of which is incorporated by reference in its entirety. Polyanionic species also include non-polymeric molecule having two or more negatively charged groups. Suitable negatively charged groups include, but are not limited to, carboxyl groups, sulfonate groups, phosphonate groups, and mixtures thereof.

Polyanions (polyanionic species) suitable for formation of useful complexes with nitrapyrin have one or more of: a formal charge of −2 or greater (i.e., greater negative charge) in dilute aqueous solution at pH 10, lower vapor pressure when compared to the vapor pressure of nitrapyrin, and/or lower volatility when compared to the volatility of nitrapyrin. In some embodiments, the vapor pressure of the nitrapyrin in the nitrapyrin complex is less than 0.5 mmHg at 20° C. Furthermore, the amount of loading of the nitrapyrin into a formulation has been significantly increased.

In some embodiments, the MW/charge ratio of a polyanion is 45-200, 45-175, 45-150, 45-125, 45-125, 45-110, 45-105, 45-100, 45-95, 45-90, 45-85, 45-80, 45-75, 50-200, 50-175, 50-150, 50-125, 50-125, 50-110, 50-105, 50-100, 50-95, 50-90, 50-85, 50-80, 50-75, 65-200, 65-175, 65-150, 65-125, 65-125, 65-110, 65-105, 90-115, 90-100, 90-105, 95-120, 95-115, 95-110, 95-105, 50, 55, 60, 65, 70, 75, 80, 85, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 1127, 128, 129, or 130. In some embodiments, the charge ratio (molecular weight/charge) is less than 200, less than 175, less than 150, less than 140, less than 130, less than 125, less than 120, less than 115, less than 110, less than 105, less than 100, less than 95, less than 90, less than 85, less than 80, less than 75, or less than 70. In some embodiments, the MW/charge ratio of a polyanion is greater than 50, greater than 55, greater than 60, greater than 65, greater than 70, greater than 75, greater than 80, greater than 85, greater than 90, greater than 95, or greater than 100.

A number of polyanionic species are suitable for the formation of complexes with nitrapyrin. In some embodiments, the polyanion has a formal charge greater than −2, greater than −3, greater than −4, greater than −5, greater than −6, greater than −7, greater than −8, greater than −9, greater than −10, greater than −15, or greater than −20 at pH 10. As used herein, greater than “−n” means greater negative charge, e.g., −3 has greater negative charge than −2. In some embodiments, the polyanions are polymeric materials having a plurality (two or more) of anionic functional groups, including, but not limited to, carboxylates, sulfonates, and the like.

In some embodiments, the polyanion is a non-polymeric molecule having a plurality (two or more) of anionic functional groups, including, but not limited to, carboxylates, sulfonates, and the like. Non-polymeric polyanions include, but are not limited to, di-, tri-, tetra-, penta-, hexa-, hepta-, octa-, nona-, and deca-carboxyls, di-, tri-, tetra-, penta-, hexa-, hepta-, octa-, nona-, and deca-sulfonates, and di-, tri-, tetra-, penta-, hexa-, hepta-, octa-, nona-, and deca-phosphonates. In some embodiment, a non-polymeric polyanion comprises an aliphatic dibasic acid. In some embodiments, a non-polymeric polyanion comprises aromatic carboxylic acid containing a 2-6 carboxylic acid groups. In some embodiments, a non-polymeric polyanion comprises aliphatic carboxylic acid containing a 2-6 carboxylic acid groups. Exemplary non-polymeric polycarboxylic acids, phosphonates, and aromatic carboxylic acids suitable for forming nitrapyrin complexes include, but are not limited to, malic acid, tartaric acid, etidronic acid, succinic acid, adipic acid, isophthalic acid, aconitic, trimesic, biphenyl-3,3′,5,5′-tetracarboxylic acid, furantetracarboxylic acid, sebacic acid, azelaic acid, isoterephtallic acid, isophthallic acid, pyromellitic acid, and mellitic acid.

The amount of nitrapyrin substitution on the polyanion is from about 5% to about 90%, of the available anionic groups, or from about 10% to about 90% of the available anionic groups, or from about 20% to about 90% of the available anionic groups, or from about 30% to about 80% of the available anionic groups, or from about 40% to about 80% of the available anionic groups, or from about 40% to about 75% of the available anionic groups, or from about 50% to about 75% of the available anionic groups. In embodiments, the nitrapyrin complex contains from about 50 g/mol anionic species to about 200 g/mol anionic species; or from about 75 g/mol anionic species to about 190 g/mol anionic species, or from about 100 g/mol anionic species to about 180 g/mol anionic species, or about 125 g/mol anionic species to about 175 g/mol anionic species.

In some embodiments, the polyanionic species comprises a polyanionic polymer. In some embodiments, a polyanionic polymer comprises a copolymer containing two or more different repeat units. A copolymer can have two, three, four, or more different repeat units. As used herein, a copolymer contains two or more different repeat units. As used herein, a terpolymer contains three or more different repeat units. As used herein, a tetrapolymer contains four or more different repeat units. A polyanionic polymer can be, but is not limited to, random copolymer, alternating copolymer, periodic copolymer, statistical copolymer, or block copolymer. In some embodiments, the polyanion can be a carboxylated polymer, a sulfonated polymer or an all-sulfonated polymer. An all sulfonated polymer can be, but is not limited to, polystyrene sulfonate. Additionally, the sulfur can be provided by polyanionic species such as ethanedisulfonic acid and 1,3-benzenedisulfonic acid.

In some embodiments, the polyanionic polymers have a high carboxylate content and sulfonate repeat units, which are very soluble in water and biodegradable. In some embodiments, a polyanionic polymer has a single repeating unit, wherein the repeating unit contains a negatively charged group. In some embodiments, a polyanionic polymer comprises a copolymer having two or more repeating units wherein at least one of the repeating units contains a negatively charged group. In some embodiments, a polyanionic polymer comprises a dipolymer having two repeating units wherein at one or both of the repeating units contains a negatively charged group. In some embodiments, a polyanionic polymer comprises a terpolymer having three or more repeating units wherein at least one of the repeating units contains a negatively charged group. In some embodiments, the polyanionic polymers are tetrapolymers having at least four different repeat units distributed along the lengths of the polymer chains, preferably with at least one repeat unit each of maleic, itaconic, and sulfonate repeat units. The repeat units are derived from corresponding monomers used in the synthesis of the polymers. In some embodiments, a polyanionic polymer contains type B, type C, and/or type G repeat units as described in detail below. In some embodiments, a polyanionc polymer contains type B and type C, type B and type G, or type C and type G repeat units as described in detail below. In some embodiments, a polyanionic polymer contains at least one repeat unit from each of three separately defined categories of repeat units, referred to herein as type B, type C, and type G repeat units, and described in detail below. In some embodiments, at least about 90 mole percent of the repeat units therein are selected from the group consisting of type B, C, and G repeat units, and mixtures thereof, the repeat units being randomly located along the polyanionic polymer. In some embodiments, the polyanionic polymer contains no more than about 10 mole percent or no more than 5 mole percent of any of (i) non-carboxylate olefin repeat units, (ii) ether repeat units, (iii) non-sulfonated monocarboxylic repeat units, (iv) non-sulfonated monocarboxylic repeat units, and/or (v) amide-containing repeat units. “Non-carboxylate” and “non-sulfonated” refers to repeat units having essentially no carboxylate groups or sulfonate groups in the corresponding repeat units.

In some embodiments, a polyanionic polymer comprises a copolymer comprising the structure represented by:

poly(Aₐ-co-A′_{a′}-co-A″_{a″}-co-D_{d})

wherein A is a first repeat unit containing a negatively charged group, A′ is optional and if present is a second repeat unit containing a negatively charged group, A″ is optional and if present is a third repeat unit containing a negatively charged group, and D is optional and if present is an uncharged repeat unit. A polyanionic polymer can contain additional negatively charged repeat units or uncharged repeat units. a is an integer greater than or equal to 1. a′, a″, and d are integers greater than or equal to zero. The value of (a+a′+a″) is greater than or equal to 2.

In some embodiments, the polyanionic polymer comprises a random copolymer having structure represented by:

poly(B_{b}-co-C_{c}-co-G_{g}-co-G′_{g′})

wherein B and C are type B and type C repeat units as described below, G and G′ are independently type G repeat units as described below, c is an integer greater than zero and b, g and g′ are integers greater than or equal to zero. In some embodiments, the ratio of b:c:(g+g′) is about 1-70:1-80:0-65. In some embodiments, the ratio of b:c:(g+g′) is about 20-65:15-75:1-35. In some embodiments, the ratio of b:c:(g+g′) is about 35-55:20-55:1-25. In some embodiments, the ratio of b+c to g+g′ is about 0.5-20:1, about 1-20:1, or about 1-10:1. In some embodiments, the ratio of b:c:g:g′ is about 10:90:0:0, about 60:40:0:0, about 50:50:0:0, or about 0:100:0:0. In some embodiments, the ratio of b:c:g:g′ is about 45:35:15:5. In some embodiments, the ratio of b:c:g:g′ is about 45:50:4:1. In some embodiments, the polymers contain less than 10%, less than 4%, less than 3%, less than 25, less than 1%, less than 0.5%, less than 0.1%, less than 0.05%, less than 0.01% or 0% repeat units that are not B, C, G, or G′.

In some embodiments, the polyanionic polymer comprises a tetrapolymer having repeat units individually and independently selected from the group consisting of type B, type C, and type G repeat units, and mixtures thereof, described in detail below. In some embodiments, a tetrapolymer contains more than four different repeat units. In some embodiments, the additional repeat units are selected from the group consisting of type B, type C, and type G repeat units, and mixtures thereof, as well as other monomers or repeat units not being type B, C, or G repeat units.

In some embodiments, a polyanionic polymer contains at least one repeat unit from each of the B, C, and G types, one other repeat unit selected from the group consisting of type B, type C, and type G repeat units, and optionally other repeat units not selected from type B, type C, and type G repeat units. In some embodiments, a polyanionic polymers comprise a single type B repeat unit, a single type C repeat unit, and two different type G repeat units, or two different type B repeat units, a single type C repeat unit, and one or more different type G repeat units.

In some embodiments, the polyanionic polymers comprise at least 90% or at least 96 mole percent of the repeat units therein selected from the group consisting of type B, C, and G repeat units, and mixtures thereof. In some embodiments, the polyanionic polymers consist of or consist essentially of repeat units selected from the group consisting of type B, C, and G repeat units, and mixtures thereof. In some embodiments, the polyanionic polymers contain <3, <2, <1, <0.5, <0.1, <0.05, <0.01, or 0 mole percent ester groups and/or noncarboxylate olefin groups.

In some embodiments, the total amount of type B repeat units in the polymer is from about 1-70 mole percent, the total amount of type C repeat units in the polymer is from about 1-80 mole percent, and the total amount of type G repeat units in the polymer is from about 0.1-65 mole percent, where the total amount of all of the repeat units in the polymer is taken as 100 mole percent. In some embodiments, the total amount of type B repeat units in the polymer is from about 20-65 mole percent, the total amount of type C repeat units in the polymer is from about 15-75 mole percent, and the total amount of type G repeat units in the polymer is from about 1-35 mole percent, where the total amount of all of the repeat units in the polymer is taken as 100 mole percent.

In some embodiments, the polyanionic polymers have one type B repeat unit, one type C repeat unit, and two different type G repeat units. In some embodiments, the one type B repeat unit is derived from maleic acid, the one type C repeat unit is derived from itaconic acid, and two type G repeat units are respectively derived from methallylsulfonic acid and allylsulfonic acid. In such polymers, the type B repeat unit can be present at a level of from about 35-55 mole percent, the type C repeat unit can present at a level of from about 20-55 mole percent, the type G repeat unit derived from methallylsulfonic acid can present at a level of from about 1-25 mole percent, and the type G repeat unit derived from allylsulfonic acid can be present at a level of from about 1-25 mole percent, where the total amount of all of the repeat units in the polymer is taken as 100 mole percent. In other embodiments, the polyanionic polymers comprise two different type B repeat units, one type C repeat unit, and one type G repeat unit. In some embodiments, the polyanionic polymer contains at least one repeat unit not selected from the group consisting of type B, type C, and type G repeat units.

In some embodiments, the mole ratio of the type B and type C repeat units in combination to the type G repeat units (that is, the mole ratio of (B+C)/G) should be about 0.5-20:1, about 2: 1-20:1, or about 2.5:1-10:1. Still further, the polymers should be essentially free (e.g., less than about 1 mole percent) of alkyloxylates or alkylene oxide (e.g., ethylene oxide)-containing repeat units, and most desirably entirely free thereof.

In some embodiments, the polyanionic polymers have a high percentage of the repeat units thereof bearing at least one anionic group, e.g., at least about 80 mole percent, at least about 90 mole percent, at least about 95 mole percent, or essentially all of the repeat units contain at least one anionic group. It will be appreciated that the B and C repeat units have two anionic groups per repeat unit, whereas the preferred sulfonate repeat units have one anionic group per repeat unit.

In some embodiments, a polyanionic terpolymer comprises a polymer backbone composition range (by mole percent, using the parent monomer names of the corresponding repeat units) of: maleic acid 35-50%; itaconic acid 20-55%; methallylsulfonic acid 1-25%; and allylsulfonic sulfonic acid 1-20%, where the total amount of all of the repeat units in the polymer is taken as 100 mole percent.

The molecular weight of the polymers can be varied, depending upon the desired properties. The molecular weight distribution for any of the polyanionic polymers can be measured by size exclusion chromatography. In some embodiments, a polyanionic polymer has a molecule weight greater than 118, greater than 150, greater than 200, greater than 300, greater than 400, or greater than 500 Da. In some embodiments, the polyanionic polymers have a molecular weight of about 100-50,000 Da. In some embodiments, the polyanionic polymers have a molecular weight of about 100-5000 Da, about 200-5000 Da, about 400-5000 Da, or about 1000-5000 Da. In some embodiments, at least 90% of the finished polyanionic polymer is at or above a molecular weight of about 100, 200, 400, or 1000 measured by size exclusion chromatography in 0.1 M sodium nitrate solution via refractive index detection at 35° C. using polyethylene glycol standards. Other methods of determining polymer molecular known in the art can also be employed.

### Type B Repeat Units

Type B repeat units can be selected from the group consisting of repeat units derived from substituted and unsubstituted monomers of maleic acid and/or maleic anhydride, fumaric acid mesaconic acid, mixtures of the foregoing, and any isomers, esters, acid chlorides, and partial or complete salts of any of the foregoing. Type B repeat units may be substituted with one or more C1-C6 straight or branched chain alkyl groups substantially free of ring structures and halo atoms, wherein substantially free means no more than about 5 mole percent or no more than about 1 mole percent of either ring structures or halo substituent. Substituents are normally bound to one of the carbons of a carbon-carbon double bond of the monomer(s) employed.

Those skilled in the art will appreciate the usefulness of in situ conversion of acid anhydrides to acids in a reaction vessel just before or even during a reaction. However, it is also understood that when corresponding esters (e.g., maleic or citraconic esters) are used as monomers during the initial polymerization, this should be followed by hydrolysis (acid or base) of pendant ester groups to generate a final carboxylated polymer substantially free of ester groups.

### Type C Repeat Units

Type C repeat units can be selected from the group consisting of repeat units derived from substituted or unsubstituted monomers of itaconic acid or itaconic anhydride, and any isomers, esters, and the partial or complete salts of any of the foregoing and mixtures of any of the foregoing. Type C repeat units may be substituted with one or more C1-C6 straight or branched chain alkyl groups substantially free of ring structures and halo atoms.

The itaconic acid monomer used to form type C repeat unit has one carboxyl group, which is not directly attached to the unsaturated carbon-carbon double bond used in the polymerization of the monomer. In some embodiments, a type C repeat unit has one carboxyl group directly bound to the polymer backbone, and another carboxyl group spaced by a carbon atom from the polymer backbone. The definitions and discussion relating to “substituted,” “salt,” and useful salt-forming cations (metals, amines, and mixtures thereof) with respect to the type C repeat units, are the same as those set forth for the type B repeat units.

In some embodiments, the type C repeat unit is an unsubstituted itaconic acid or itaconic anhydride, either alone or in various mixtures. If itaconic anhydride is used as a starting monomer, it is normally useful to convert the itaconic anhydride monomer to the acid form in a reaction vessel just before or even during the polymerization reaction. Any remaining ester groups in the polymer are normally hydrolyzed, so that the final carboxylated polymer is substantially free of ester groups.

### Type G Repeat Units

Type G repeat units can be selected from the group consisting of repeat units derived from substituted or unsubstituted sulfonated monomers possessing at least one carbon-carbon double bond and at least one sulfonate group and which are substantially free of aromatic rings and amide groups, and any isomers, and the partial or complete salts of any of the foregoing, and mixtures of any of the foregoing. Type G repeat units may be substituted with one or more C₁-C₆ straight or branched chain alkyl groups substantially free of ring structures and halo atoms.

In some embodiments, type G repeat units can be selected from the group consisting of C₁-C₈ straight or branched chain alkenyl sulfonates, substituted forms thereof, and any isomers or salts of any of the foregoing; especially preferred are alkenyl sulfonates selected from the group consisting of vinyl, allyl, and methallylsulfonic acids or salts.

In some embodiments, the type G repeat units are derived from vinylsulfonic acid, allylsulfonic acid, and methallylsulfonic acid, either alone or in various mixtures. It has also been found that alkali metal salts of these acids are also highly useful as monomers. In this connection, it was unexpectedly discovered that during polymerization reactions yielding the novel polymers disclosed herein, the presence of mixtures of alkali metal salts of these monomers with acid forms thereof does not inhibit completion of the polymerization reaction.

By the same token, mixtures of monomers of maleic acid, itaconic acid, sodium allyl sulfonate, and sodium methallyl sulfonate do not inhibit the polymerization reaction.

Syntheses of BC and BCG polymers are described in WO 2015/031521, incorporated herein by reference in its entirety.

### A. 1. Class I Polymers

### Class IA Polymers

Class IA polymers contain both carboxylate and sulfonate functional groups, but are not the tetra- and higher order polymers of Class I. For example, terpolymers of maleic, itaconic, and allylsulfonic repeat units will function as the polyanionic polymer component of the formulation. The Class IA polymers thus are normally homopolymers, copolymers, and terpolymers, advantageously including repeat units individually and independently selected from the group consisting of type B, type C, and type G repeat units, without the need for any additional repeat units. Such polymers can be synthesized in any known fashion, and can also be produced using the previously described Class I polymer synthesis.

Class IA polymers preferably have the same molecular weight ranges and the other specific parameters (e.g., pH and polymer solids loading) previously described in connection with the Class I polymers, and maybe converted to partial or complete salts using the same techniques described with reference to the Class I polymers. Class IA polymers are most advantageously synthesized using the techniques described above in connection with the Class I polymers.

### 2. Class II Polymers

Broadly speaking, the polyanionic polymers of this class are of the type disclosed in U.S. Pat. No. 8,043,995, which is incorporated herein by reference in its entirety. The polymers include repeat units derived from at least two different monomers individually and respectively taken from the group consisting of what have been denominated for ease of reference as B′ and C′ monomers; alternately, the polymers may be formed as homopolymers or copolymers from recurring C′ monomers. The repeat units may be randomly distributed throughout the polymer chains.

In detail, repeat unit B′ is of the general formula

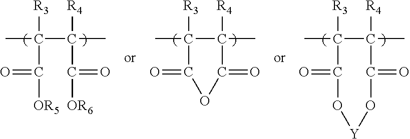

or and repeat unit C is of the general formula

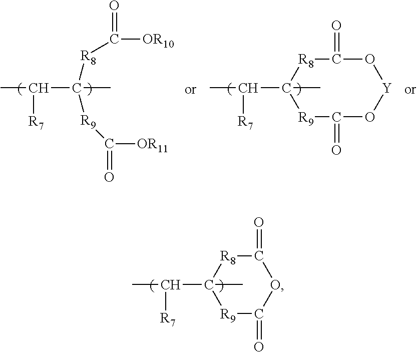

wherein each R₇ is individually and respectively selected from the group consisting of H, OH, C₁-C₃₀ straight, branched chain and cyclic alkyl or aryl groups, C₁-C₃₀ straight, branched chain and cyclic alkyl or aryl formate (C₀), acetate (C₁), propionate (C₂), butyrate (C₃), etc. up to C₃₀ based ester groups, R′CO₂ groups, OR′ groups and COOX groups, wherein R′ is selected from the group consisting of C₁-C₃₀ straight, branched chain and cyclic alkyl or aryl groups and X is selected from the group consisting of H, the alkali metals, NH₄ and the C₁-C₄ alkyl ammonium groups, R₃ and R₄ are individually and respectively selected from the group consisting of H, C₁-C₃₀ straight, branched chain and cyclic alkyl or aryl groups, R₅, R₆, R₁₀ and R₁₁ are individually and respectively selected from the group consisting of H, the alkali metals, NH₄ and the C₁-C₄ alkyl ammonium groups, Y is selected from the group consisting of Fe, Mn, Mg, Zn, Cu, Ni, Co, Mo, V, W, the alkali metals, the alkaline earth metals, polyatomic cations containing any of the foregoing (e.g., VO⁺²), amines, and mixtures thereof; and R₈ and R₉ are individually and respectively selected from the group consisting of nothing (i.e., the groups are non-existent), CH₂, C₂H₄, and C₃H₆.

As can be appreciated, the Class II polymers typically have different types and sequences of repeat units. For example, a Class II polymer comprising B′ and C′ repeat units may include all three forms of B′ repeat units and all three forms of C′ repeat units. However, for reasons of cost and ease of synthesis, the most useful Class II polymers are made up of B′ and C′ repeat units. In the case of the Class II polymers made up principally of B′ and C′ repeat units, R₅, R₆, R₁₀, and R₁₁ are individually and respectively selected from the group consisting of H, the alkali metals, NH₄, and the C₁-C₄ alkyl ammonium groups. This particular Class II polymer is sometimes referred to as a butanedioic methylenesuccinic acid copolymer and can include various salts and derivatives thereof.

The Class II polymers may have a wide range of repeat unit concentrations in the polymer. For example, Class II polymers having varying ratios of B′:C′ (e.g., 10:90, 60:40, 50:50 and even 0:100) are contemplated and embraced by the presently disclosed subject matter. Such polymers would be produced by varying monomer amounts in the reaction mixture from which the final product is eventually produced and the B′ and C′ type repeat units may be arranged in the polymer backbone in random order or in an alternating pattern.

The Class II polymers may have a wide variety of molecular weights, ranging for example from 500-5,000,000, depending chiefly upon the desired end use. Additionally, n can range from about 1-10,000 and more preferably from about 1-5,000.

Class II polymers can be synthesized using dicarboxylic acid monomers, as well as precursors and derivatives thereof. For example, polymers containing mono and dicarboxylic acid repeat units with vinyl ester repeat units and vinyl alcohol repeat units are contemplated; however, polymers principally comprised of dicarboxylic acid repeat units are preferred (e.g., at least about 85%, and more preferably at least about 93%, of the repeat units are of this character). Class II polymers may be readily complexed with salt-forming cations using conventional methods and reactants.

In some embodiments, the Class II polymers is composed of maleic and itaconic B′ and C′ repeat units and have the generalized formula:

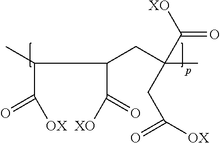

where X is either H or another salt-forming cation, depending upon the level of salt formation.

In a specific example of the synthesis of a maleic-itaconic Class II polymer, acetone (803 g), maleic anhydride (140 g), itaconic acid (185 g) and benzoyl peroxide (11 g) were stirred together under inert gas in a reactor. The reactor provided included a suitably sized cylindrical jacketed glass reactor with mechanical agitator, a contents temperature measurement device in contact with the contents of the reactor, an inert gas inlet, and a removable reflux condenser. This mixture was heated by circulating heated oil in the reactor jacket and stirred vigorously at an internal temperature of about 65-70° C. This reaction was carried out over a period of about 5 hours. At this point, the contents of the reaction vessel were poured into 300 g water with vigorous mixing. This gave a clear solution. The solution was subjected to distillation at reduced pressure to drive off excess solvent and water. After sufficient solvent and water have been removed, the solid product of the reaction precipitates from the concentrated solution, and is recovered. The solids are subsequently dried in vacuo.

In some embodiments, the polyanionic polymer has repeat unit molar composition of 45 mole percent maleic repeat units, 50 mole percent itaconic repeat units, 4 mole percent methallylsulfonate repeat units, and 1 mole percent allylsulfonate repeat units. This polymer is referred to herein as the “T5” polymer.

In some embodiments the polyanionic polymer comprises: 45% maleic repeat units, 35% itaconic repeat units, 15% methallylsulfonate repeat units, and 5% allylsulfonate repeat units.

In some embodiments, the polyanionic polymers comprises: 45% maleic repeat units, 50% itaconic repeat units, 4% methallylsulfonate repeat units, and 1% allylsulfonate repeat units.

In some embodiments, a nitrapyrin complex can be formed with two or more different polyanionic polymers.

In embodiments, nitrapyrin can be present as a mixture of the complex and the free form. The ratio of complex to free form can be from 1000:1 to 0.1:1 such that the formulations can reduce the volatilization losses of nitrapyrin to atmosphere by at least 10% as compared to an identical formulation lacking the complex described herein. Accordingly, the formulations described herein can simultaneously comprise the complex and the free form so long as the volatilization losses are reduced as described elsewhere herein.

### B. Amide-Based Corrosion Inhibitor

In some embodiments, the amide-based corrosion inhibitor is selected from a neutralizing amine, a film-forming amine, and a combination thereof. In general, neutralizing amines are compounds (e.g., weak bases) that control corrosion by neutralizing corrosive species (that are typically acidic in nature). In some embodiments, the amine-based inhibitor reduces corrosion of any metal and or plastic-containing surfaces of parts and/or components of agricultural equipment that is being contacted by the compositions and/or formulations disclosed herein. Neutralizing amines employed in the disclosed noncorrosive formulation include, but are not limited to, ammonia (NH₃), cyclohexylamine (CHA), methoxypropylamine (MPA), monoethanolamine (MEA), morpholine (MOR), 3-methoxypropylamine (MOPA), ethylamine (ET), dimethylamine (DMA), 1,8-dia 1,8-Diazabicyclo(5.4.0)undec-7-ene (DBU), 2-diethylaminoethanol (DEAE), ethanolamine (ETA), diethanolamine (DEA), diethylhydroxylamine (DEHA), methyldiethanolamine (MDEA), and a combination thereof. In some embodiments, the neutralizing amine is monoethanolamine (MEA).

Film-forming amines are compounds that provide corrosion protection by forming a physicochemical barrier between the metallic surface (e.g., of the agricultural equipment) and the working solution (e.g., formulation) to prevent corrosion from occurring. In some embodiments, the film-forming amine is an amine of formula (I):

R₁—[NH—R₂]ₙ—NH₂
wherein n is an integer between 0 and 7,
R₁ is a substituted or unsubstituted (C₁-C₂₂) alkyl group, and
R₂ is a substituted or unsubstituted (C₂-C₁₀) alkyl group.

In some embodiments, n is 0. Such film-forming amines are referred as monoamines. Exemplary monoamines include, but are not limited to, methylamine, ethylamine, propylamine, n-butylamine, n-pentylamine, n-hexylamine, n-heptylamine, n-octylamine, n-nonylamine, n-decylamine, and/or n-undecylamine. In some embodiments, the monoamine is a fatty amine. Examplary fatty amines include, but are not limited to, dodecylamine, tridecylamine, tetradecylamine, pentadecylamine, hexadecylamine, heptadecylamine, octadecylamine, nondecylamine, eicosylamine, heneicosylamine, or docosylamine.

In some embodiments, n is not 0. Such film-forming amines are referred to as polyamines. Exemplary polyamines include, but are not limited to, an amine of formula (I), wherein n is an integer selected from 1, 2, 3, 4, 5, 6, and 7; R₁ is a substituted or unsubstituted (C₁-C₂₂) alkyl group, and R₂ is a substituted or unsubstituted (C₂-C₁₀) alkyl group. In some embodiments, n is an integer selected from 1 and 2.

In some embodiments, R₁ is a substituted or unsubstituted (C₈-C₂₂) alkyl group. In some embodiments, R₁ is a substituted or unsubstituted (C₁₂-C₁₈) alkyl group. In some embodiments, R₁ is a substituted or unsubstituted (C₂-C₈) alkyl group.

In some embodiments, R₂ is a substituted or unsubstituted (C₂-C₁₀) alkyl group. In some embodiments, R₂ is a substituted or unsubstituted (C₂-C₈) alkyl group. In some embodiments, R₂ is a substituted or unsubstituted (C₂-C₆) alkyl group.

The amount of the amine-based corrosion inhibitor present in the formulation can vary. In some embodiments, the amine-based corrosion inhibitor (e.g., a neutralizing amine and/or film-forming amine) is present in the noncorrosive nitrapyrin formulation in an amount of from about 0.01% to about 10%, about 0.05% to about 8%, about 0.1% to about 5%, or about 0.5% to about 3.5% by weight based on the total weight of the noncorrosive nitrapyrin formulation. In some embodiments, the amine-based corrosion inhibitor (e.g., a neutralizing amine and/or film-forming amine) is present in the noncorrosive nitrapyrin formulation in an amount of from about 0.01% to about 5%, from about 0.05 to about 5%, from about 0.05% to about 3%, from about 0.05% to about 2%, from about 0.05% to about 1%, or from about 0.05% to about 0.5% by weight based on the total weight of the noncorrosive nitrapyrin formulation. In some embodiments, the amine-based corrosion inhibitor (e.g., a neutralizing amine and/or film-forming amine) is present in the noncorrosive nitrapyrin formulation in an amount of from about 0.1% to about 5%, from about 0.1 to about 4%, from 0.1 to about 3.5%, from 0.1 to about 3.0%, from 0.1 to about 2.0%, or from about 0.1% to about 1% by weight based on the total weight of the noncorrosive nitrapyrin formulation. In some embodiments, the amount of amide-based corrosion inhibitor present in the noncorrosive nitrapyrin formulation is less than about 5%, 4.5%, 4%, 3.5%, 3%, 2.5%, 2%, 1.5%, 1%, or less than about 0.5% by weight based on the total weight of the formulation.

### C. Organic Solvents and Additives

In some embodiments, the solvent is an organic solvent. In some embodiments, the solvent is one or more polar organic solvent(s). In some embodiments, the one or more polar organic(s) solvent are EPA approved. EPA-approved solvents are those that are approved for food and non-food use and found in the electronic code of federal regulations, for example in Title 40, Chapter I, Subchapter E, Part 180. EPA-approved solvents include, but are not limited to, the solvents listed in Table 1.

TABLE 1
EPA-approved solvents

| | |
|---|---|
| 1,3-Propanediol (CAS Reg. No. 504-63-2) | Isopropyl-3-hydroxybutyrate (CAS Reg. |
| | No. 54074-94-1) |
| 2-Ethylhexanol | Kerosene, U.S.P. reagent |
| 2-methyl-1,3-propanediol (CAS Reg. | Lactic acid |
| No. 2163-42-0) | |
| 2-Methyl-2,4-pentanediol | Lactic acid, 2-ethylhexyl ester (CAS Reg. |
| | No. 6283-86-9) |
| Acetic anhydride | Lactic acid, n-propyl ester, (S); (CAS Reg. |
| | No. 53651-69-7) |
| Acetone (CAS Reg. No. 67-64-1) | Mesityl oxide |
| Ammonium hydroxide | Methyl 5-(dimethylamino)-2-methyl-5- |
| | oxopentanoate (1174627-68-9) |
| Amyl acetate | Methyl alcohol |
| Benzyl acetate (CAS Reg. No. 140-11-4) | Methyl esters of fatty acids derived from |
| | edible fats and oils |
| C₁₀₋₁₁ rich aromatic hydrocarbons (CAS | Methyl isobutyl ketone |
| Reg. No. 64742-94-5) | |
| C₁₁₋₁₂ rich aromatic hydrocarbons (CAS | Methyl isobutyrate (CAS Reg. |
| Reg. No. 64742-94-5) | No. 547-63-7) |
| C₉ rich aromatic hydrocarbons (CAS Reg. | Methyl n-amyl ketone (CAS Reg. |
| No. 64742-95-6) | No. 110-43-0) |
| Choline chloride (CAS Reg. No. 67-48-1) | Mineral oil |
| Cod liver oil | Morpholine 4-C₆₋₁₂ Acyl Derivatives (CAS |
| | Reg. No. 887947-29-7) |
| Cyclohexane | n-Butanol (CAS Reg. No. 71-36-3) |
| Cyclohexanone | n-Butyl benzoate (CAS Reg. No. 136-60-7) |
| Decanamide, N,N-dimethyl (CAS Reg. | n-Butyl-3-hydroxybutyrate (CAS Reg. |
| No. 14433-76-2) | No. 53605-94-0) |
| Diethylene Glycol (CAS No. 111-46-6) | n-Decyl alcohol (CAS Reg. No. 112-30-1) |
| Diethylene glycol mono butyl ether (CAS | n-Hexyl alcohol (CAS Reg. No. 111-27-3) |
| Reg. No. 112-34-5) | |
| Diethylene Glycol MonoEthyl Ether (CAS | N-Methylpyrrolidone (CAS Reg. |
| Reg. No. 111-90-0) | No. 872-504) |
| Diethylphthalate | n-Octyl alcohol (CAS Reg. No. 111-87-5) |
| Diisopropyl adipate (CAS Reg. | n-Propanol |
| No. 6938-94-9) | |
| Dimethyl adipate (CAS Reg. No. 627-93-0) | Octanamide, N,N-dimethyl (CAS Reg. |
| | No. 1118-92-9) |
| Dimethyl glutarate (CAS Reg. No. | Oxo-decyl acetate (CAS reg. |
| 1119-40-0) | No. 108419-33-6) |
| Dimethyl succinate (CAS Reg. No. 106-65- | Oxo-heptyl acetate (CAS Reg. |
| 0) | No. 90438-79-2) |
| Dimethyl sulfoxide (CAS Reg. No. | Oxo-hexyl acetate (CAS Reg. |
| 67-68-5) | No. 88230-35-7) |
| Di-n-butyl carbonate (CAS Reg. | Oxo-nonyl acetate (CAS Reg. |
| No. 542-52-9) | No. 108419-34-7) |
| Dipropylene glycol | Oxo-octyl acetate (CAS Reg. |
| | No. 108419-32-5) |
| Distillates, (Fishcher-Tropsch), heavy, | Oxo-tridecyl acetate (CAS Reg. |
| C18-C50, branched, cyclic and linear (CAS | No. 108419-35-8) |
| Reg. No. 848301-69-9) | |
| d-Limonene (CAS Reg. No. 5989-27-5) | Petroleum hydrocarbons, light odorless |
| | conforming to 21 C.F.R. § 172.884 |
| Edible fats and oils | Phenol |
| Ethyl acetate | Propanoic acid, 2-methyl-, monoester with |
| | 2,2,4-trimethyl-1,3-pentanediol (CAS Reg. |
| | Reg. No. 25265-77-4) |
| Ethyl alcohol | Propylene glycol |
| Ethyl esters of fatty acids derived from | Propylene glycol monomethyl ether (CAS |
| edible fats and oils | Reg. No. 107-98-2) |
| Ethylene glycol (CAS Reg. No. 107-21-1) | Soybean oil-derived fatty acids |
| Glycerol mono-, di-, and triacetate | Tall oil fatty acid (CAS Reg. |
| | No. 61790-12-3) |
| Hydrochloric acid | Tetraethylene glycol (CAS Reg. |
| | No. 112-60-7) |
| Isobornyl acetate | Toluenesulfonic acid |
| Isobutyl acetate (CAS Reg. No. 110-19-0) | Triacetin (glyceryl triacetate) |
| Isobutyl isobutyrate (CAS Reg. | Xylene |
| No. 97-85-8) | |
| Isobutyric acid (CAS Reg. No. 79-31-2) | γ-Butyrolactone |
| Isopropyl myristate (CAS Reg. | |
| No. 110-27-0) | |

In some embodiments, the organic solvent is selected from a sulfone, a sulfoxide, an oil, an aromatic solvent, a halogenated solvent, a glycol-based solvent, a fatty acid-based solvent, an acetate-containing solvent, a ketone-containing solvent, an ether polyol-containing solvent, an amide-containing solvent, and combinations thereof. In some embodiments, the one or more organic solvent(s) are all relatively free of water. In some embodiments, the organic solvent contains less than about 10% w/w, about 9% w/w, about 8% w/w, about 7% w/w, about 6% w/w, about 5% w/w, about 4% w/w, about 3% w/w, about 2% w/w, about 1% w/w, about 0.9% w/w, about 0.8% w/w, about 0.7% w/w, about 0.6% w/w, about 0.5% w/w, about 0.4% w/w, about 0.3% w/w, or less than about 0.1% w/w of water based on the total weight of the solvent. In some embodiments, the organic solvent is a liquid at 20° C.

In some embodiments, the organic solvent is a sulfone. A sulfone solvent can be, but is not limited to, sulfolane, methyl sulfolane (3-methyl sulfolane), and dimethylsulfone, and a combination thereof. In some embodiments, the organic solvent is a sulfoxide. A sulfoxide solvent can be, but is not limited to, dimethyl sulfoxide.

In some embodiments, the organic solvent is an ether-polyol. An ether-polyol solvent can be, but is not limited to, polyethylene glycols, polypropylene glycols, polyalkylene glycols, and related compounds. In some embodiments, the polyethylene glycol has two terminal alcohols (e.g., polyethylene glycol 3350). Exemplary polyethylene glycols include, but are not limited to, diethylene glycol, triethylene glycol, and a combination thereof. Exemplary polypropylene glycols include, but are not limited to, dipropylene glycol, tripropylene glycol, and a combination thereof. In some embodiments, a polypropylene glycol has three terminal alcohols. Exemplary polypropylene glycols having three terminal alcohols, known as propoxylated glycerol, include, but are not limited to, Dow PT250 (which is a glyceryl ether polymer containing three terminal hydroxyl groups with a molecular weight of 250) and Dow PT700 (which is a glyceryl ether polymer containing three terminal hydroxyl groups with a molecular weight of 700). In some embodiments, ether polyol comprises a polyethylene or a polypropylene glycol in the molecular weight range of between about 200 and about 10,000 Da. In some embodiments, one or more of the hydroxyl groups present in the ether polyol is modified. For example, in some embodiments, one or more of the hydroxyl groups present in the ether polyol are alkylated and/or esterified. Exemplary modified ether polyols include, but are not limited to, triacetin, n-butyl ether of diethylene glycol, ethyl ether of diethylene glycol, methyl ether of diethylene glycol, acetate of the ethyl ether of dipropylene glycol, and a combination thereof. In some embodiments, the ether polyol is a cyclic carbonate ester (e.g., propylene carbonate). It has been found that the disclosed compositions containing ether polyols are more suitable for formation of higher solids and/or actives content than previously described compositions containing esters.

In some embodiments, the organic solvent is a glycol-based solvent. A glycol is an alcohol that contains two hydroxyl (—OH) groups that are attached to different carbon atoms (e.g., terminal carbon atoms). The simplest glycol is ethylene glycol, although the solvent should not be limited thereto. In some embodiments, the organic solvent is propane-1,2,3-triol.

In some embodiments, the organic solvent is an oil. Exemplary oils include, but are not limited to, mineral oil and/or kerosene.

In some embodiments, the organic solvent is a fatty acid-based solvent. In some embodiments, the fatty acid contains between 3 to about 20 carbon atoms. Example of fatty acid-based solvents include, but are not limited to, a dialkyl amide of a fatty acid (e.g., a dimethylamide). Examples of a dimethylamide of a fatty acid include, but are not limited to, a dimethyl amide of a caprylic acid, a dimethyl amide of a C₈-C₁₀ fatty acid (Agnique AMD810), a dimethyl lactamide (Agnique AMD3L), and a combination thereof.

In some embodiments, the organic solvent is a ketone-containing solvent. Examples of ketone-containing solvent include, but are not limited to, isophorone, trimethylcyclohexanone, and a combination thereof.

In some embodiments, the organic solvent is an acetate-containing solvent. Examples of acetate-containing solvents include, but are not limited to, acetate, hexyl acetate, heptyl acetate, and a combination thereof.

In some embodiments, the organic solvent is an amide-containing solvent. Examples of amide-containing solvents include, but are not limited to, Rhodiasolv ADMA10 (CAS Reg. No. 14433-76-2; N,N-dimethyloctanamide), Rhodiasolv ADMA810 (CAS Reg. No. 1118-92-9/14433-76-2; blend of N,N-Dimethyloctanamide and N,N-diemthyldecanamide), Rhodiasolv PolarClean (CAS Reg. No. 1174627-68-9; methyl 5-(dimethylamino)-2-methyl-5-oxopentanoate), and a combination thereof.

In some embodiments, the organic solvent is a halogentated solvent. In some embodiments, the halogentated solvent is a halogentated aromatic hydrocarbon. An example of a halogenated aromatic hydrocarbon is chlorobenzene. In some embodiments, the halogentated solvent is a halogentated aliphatic hydrocarbon. An example of a halogenated aliphatic hydrocarbon is 1,1,1-trichloroethane.

In some embodiments, the organic solvent is an aromatic solvent. In some embodiments, the aromatic solvent is an aromatic hydrocarbon. Exemplary aromatic hydrocarbons include, but are not limited to, benzene, naphthylene, and a combination thereof.

In some embodiments, the aromatic hydrocarbon is substituted. Examples of substituted aromatic hydrocarbons include, but are not limited to, alkyl substituted benzenes and/or alkyl substituted napthalenes. Examples of alkyl substituted benzenes include xylene, toluene, propylbenzene, and a combination thereof. In some embodiments, the organic solvent comprises xylene. In some embodiments, the aromatic hydrocarbon is a mixture of substituted and unsubstituted aromatic hydrocarbons, such as, but not limited to a mixture of naphthenic and alkyl substituted naphtalene.

In some embodiments, the aromatic solvent is a mixture of hydrocarbons. For example, in some embodiments, the aromatic solvent is aromatic 100, a solvent containing Naphtha (CAS Reg. No. 64742-95-6), which is a combination of hydrocarbons obtained from distillation of aromatic streams consisting predominantly of aromatic hydrocarbons (C₈ through C₁₀), or aromatic 200, a solvent containing a mixture of: aromatic hydrocarbon (C₁₁-C₁₄) present in 50-85% by weight; Naphthalene (CAS Reg. No. 91-20-3) present in 5-20% by weight; aromatic hydrocarbon (C₁₀) not including naphthalene present in 5-15% by weight; and aromatic hydrocarbon (C₁₅-C₁₆) present in 5-15% by weight based on the total weight of the aromatic 200 composition. In some embodiments, the aromatic hydrocarbon is a mixture of aromatic 100 and aromatic 200.

In some embodiments, an organic solvent can be, but is not limited to, an aromatic solvent (such as but not limited to, alkyl substituted benzene, xylene, propyl benzene, mixed naphthalene and alkyl naphthalene); and mineral oils; kerosene; dialkyl amides of fatty acids, (including, but not limited to, dimethylamides of fatty acids, dimethyl amide of caprylic acid); chlorinated aliphatic and aromatic hydrocarbons (including, but not limited to, 1,1,1-trichloroethane, chlorobenzene); esters of glycol derivatives (e.g., n-butyl, ethyl, or methyl ether of diethyleneglycol and acetate of the methyl ether of dipropylene glycol); ketone-containing solvents (e.g., including, but not limited to, isophorone and trimethylcyclohexanone (dihydroisophorone)); and acetate-containing solvents (including, but not limited to, hexyl and heptyl acetate).

In some embodiments, an organic solvent can be, but is not limited to, aromatic 100, aromatic 200, a sulfone, a sulfoxide, xylenes, glycol-based solvent, a ether-polyol and/or polyglycol (e.g., dipropylene glycol, Dow PT250, Dow PT700, PT250, triethylene glycol, tripropylene glycol, propane-1,2,3-triol, polyethylene glycol 3350, propylene carbonate, triacetin), dialkylamides of saturated monocarboxylic fatty acids containing between 3 and 20 carbon atoms (such as Agnique AMD810, Agnique AMD3L), amide-containing solvent (e.g., Rhodiasolv ADMA10, Rhodiasolv, Rhodiasolv PolarClean and ADMA810), dialkylamides of alpha-hydroxycarboxylic acids containing between 2 and 10 carbon atoms, such as Agnique AMD3L, Rhodiasolv PolarClean, or mixtures thereof. In some embodiments, the organic solvent is selected from Agnique AMD810, Agnique AMD3L, Rhodiasolv ADMA10, Rhodiasol ADMA810, Rhodiasol PolarClean (methyl 5-(dimethylamino)-2-methyl-5-oxopentanoate), dimethyl sulfoxide, propane-1,2,3-triol, xylenes, and mixtures thereof.

In some embodiments, the organic solvent is relatively free of water. In some embodiments, the organic solvent contains less than about 10% w/w, about 9% w/w, about 8% w/w, about 7% w/w, about 6% w/w, about 5% w/w, about 4% w/w, about 3% w/w, about 2% w/w, about 1% w/w, about 0.9% w/w, about 0.8% w/w, about 0.7% w/w, about 0.6% w/w, about 0.5% w/w, about 0.4% w/w, about 0.3% w/w, or less than about 0.1% w/w of water based on the total weight of the solvent.

In some embodiments, the nitrapyrin complex can be formulated with two or more different solvent types. In some embodiments, the nitrapyrin complex can be formulated in two different solvent types that can exhibit high solvation, lack of volatility, reduced corrosion behavior, and suitable environmental and toxicological profiles. In some embodiments, the two different solvent types to solvate the nitrapyrin complex can be selected from two different aromatic solvents, two different sulfones, two different amide-containing solvents, two different ether polyols, two different sulfoxides, two different amide-containing solvents, two different fatty acid-based solvents, or a sulfoxide and an aromatic solvent, or a sulfoxide and an amide-containing solvent or a sulfoxide and an ether polyol. In some embodiments, the two different solvent types are xylene and dimethylsulfoxide. In some embodiments, the xylene is further mixed with ethylbenzene. In some embodiments, the two different solvent types are dimethyl sulfoxide and Rhodiasolv PolarClean. In some embodiments, the two different solvent types are dimethyl sulfoxide and propane-1,2,3-triol. In some embodiments, dimethyl sulfoxide and propane-1,2,3-triol are further mixed with Rhodiasolv PolarClean to render a formulation containing three different solvent types. The amount of each solvent type present in the composition can vary. In some embodiments, the first solvent of the two or more different solvent types is present in an amount ranging from about 10% to about 90%, from about 20% to about 80%, from about 30% to about 70%, from about 40% to about 60% w/w based on the total weight of the composition. In some embodiments, the second solvent of the two or more different solvent type is present in an amount ranging from about 10% to about 90%, from about 20% to about 80%, from about 30% to about 70%, from about 40% to about 60% w/w based on the total weight of the composition.

In some embodiments, solvency of the nitrapyrin (of formulations comprising a nitrapyrin complex) in solution/solvent at 20° C. is greater than 15% w/w (nitrapyrin to total weight), for example from about 15 to about 22% w/w, or about 17% to about 21% w/w, or greater than 16% w/w, greater than 17% w/w, greater than 18% w/w, greater than 19% w/w, greater than 20% w/w, greater than 21% w/w, greater than 22% w/w, greater than 23% w/w, greater than 24% w/w, or greater than 25% w/w greater than 26% w/w, greater than 27% w/w, greater than 28% w/w, greater than 29% w/w, greater than 30% w/w, greater than 35% w/w, greater than 40% w/w, or greater than 45% w/w.

The solvent can be present in the noncorrosive nitrapyrin formulation at an amount from 0.1% w/v to about 99.9% w/v. In some embodiments, the amount of solvent will be minimized as the amount of nitrapyrin and/or nitrapyrin complex is maximized. In some embodiments, the amount of solvent is less than 80% w/v, less than 79% w/v, less than 78% w/v, less than 77% w/v, less than 76% w/v, less than 75% w/v, less than 74% w/v, less than 73% w/v, less than 72% w/v, less than 71% w/v, less than 70% w/v, less than 65% w/v, less than 60% w/v, or less than 55% w/v. In embodiments, the amount of solvent is from 55% w/v to about 98% w/v; or from about 60% w/v to about 97% w/v; or from about 61% w/v to about 95% w/v; or from about 62% w/v to about 90% w/v; or from about 63% w/v to about 85% w/v; or from about 64% w/v to about 80% w/v. In some embodiments, the amount of solvent is from about 10% w/v to about 90% w/v, from about 20% w/v to about 80% w/v, from about 50% w/v to about 70% w/v, or from about 60% w/v to about 70% w/v. In some embodiments, the amount of solvent is from about 10% w/v to about 50% w/v, or from about 10% w/v to about 40% w/v, or from about 10% w/v to about 30% w/v, or from about 10% w/v to about 20% w/v. In some embodiments, the amount of solvent is from about 49.9% to about 98.9% w/v, from about 50% w/v to about 90% w/v, or from about 50% w/v to about 80% w/v, or from about 50% w/v to about 70% w/v, or from about 50% w/v to about 65% w/v.

In some embodiments, the noncorrosive nitrapyrin formulation further comprises one or more additives. Exemplary additives include, but are not limited to, a surface active agent, an antifoam agent, a dispersant, or a combination thereof.

In some embodiments, the additive is a surface active agent (e.g., a surfactant). In some embodiments, the surface active agent is selected from polyoxyethylene tridecyl ether phosphate (Rhodafac RS-610), propylene oxide ethylene oxide polymer monobutyl ether (Antarox B848), a mixture of castor oil, ethoxylated, oleate (Alkamuls VO/2003), 4-dodecylbenzenesulfonic acid and salts thereof (e.g., dodecylbenzenesulfonate, sodium salt, etc.), and a combination thereof. The amount of surface active agent in the formulation can vary. In some embodiments, the amount of surface active agent in the formulation is from about 0.1% to about 20%, from about 0.1% to about 10%, from about 1% to about 10%, from about 3% to about 8%, from about 5% to about 8% or from about 10% to about 20%, from about 12% to about 18% or from about 14% to about 16% by weight based on the total weight of the formulation.

In some embodiments, the additive is an antifoam agent. In some embodiments, the antifoam agent is selected from and oil-based antifoam agent, a powder-based antifoam agent, a water-based antifoam agent, a silicone-based anti-foam agent, and EO/PO-based antifoam agent, an alkyl polyacrylate based foam agent, and a combination thereof. Exemplary oil-based antifoam agents include, but are not limited to, mineral oil, vegetable oil, white oil, a wax, hydrophobic silica. Exemplary waxes include, but are not limited to, ethylene bis stearamide (EBS), paraffin waxes, ester waxes, hydrocarbon waxes, fatty alcohol waxes, and a combination thereof. Exemplary powder-based antifoam agents include, but are not limited to, oil based antifoam agents on a particulate carrier like silica. Exemplary silicone-based antifoam agents include, but are not limited to, polymers with a silicon backbone, silicon compounds comprising a hydrophobic silica dispersant in a silicone oil, or silicone treated silica. Exemplary EO/PO based antifoaming agents include, but are not limited to, polyethylene glycol and polypropylene glycol copolymers. The amount of antifoam agent in the formulation can vary. In some embodiments, the amount of antifoam agent in the formulation is from 0.1% to about 20%, from about 0.1% to about 10%, from about 1% to about 10%, from about 3% to about 8%, from about 5% to about 8% or from about 10% to about 20%, from about 12% to about 18% or from about 14% to about 16% by weight based on the total weight of the formulation.

In some embodiments, the additive is a dispersant. In some embodiments, the dispersant is selected from soap powder, turkey red oil, alkyl sulphonates, alkyl acryl sulphonates, formaldehyde, lignin sulphonates, and a combination thereof. The amount of antifoam agent in the formulation can vary. In some embodiments, the amount of antifoam agent in the formulation is from 0.1% to about 20%, from about 0.1% to about 10%, from about 1% to about 10%, from about 3% to about 8%, from about 5% to about 8% or from about 10% to about 20%, from about 12% to about 18% or from about 14% to about 16% by weight based on the total weight of the formulation.

### D. Formulation

In some embodiments, the noncorrosive formulation comprises nitrapyrin in the form of a complex with a polyanion. Advantageously, nitrapyrin complexes have been found to provide excellent loading heretofore not disclosed. Advantages of the highly concentrated formulations include lower cost of shipping and ease of handling as well as a low use rate. In embodiments, the formulations comprise nitrapyrin in a range from about 20% to about 50% by wt. based on the total weight of the formulation. In some embodiments, the formulations comprise nitrapyrin in a range from about 21% to about 49% by wt. based on the total weight of the formulation. In some embodiments, the formulations comprise nitrapyrin in a range from about 22% to about 48% by wt. based on the total weight of the formulation. In some embodiments, the formulations comprise nitrapyrin in a range from about 23% to about 47% by wt. based on the total weight of the formulation. In some embodiments, the formulations comprise nitrapyrin in a range from about 24% to about 46% by wt. based on the total weight of the formulation. In some embodiments, the formulations comprise nitrapyrin in a range from about 25% to about 45% by wt. based on the total weight of the formulation. In some embodiments, the formulations comprise nitrapyrin in a range from about 26% to about 40% by wt. based on the total weight of the formulation. In some embodiments, the formulations comprise nitrapyrin in a range from about 27% to about 35% by wt. based on the total weight of the formulation. In some embodiments, the formulations comprise nitrapyrin in a range from about 28% to about 32% by wt. based on the total weight of the formulation. In some embodiments, the formulations comprise nitrapyrin in an amount of about 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50% by wt. based on the total weight of the formulation.

In some embodiment the amount of nitrapyrin complex present in the formulation can vary. For example, in some embodiments, the amount of nitrapyrin complex present in the formulation is from about 1% to about 90%, from about 1% to about 80%, from about 1% to about 60%, from about 1% to about 50%, from about 1% to about 40%, from about 1% to about 30% from about 1% to about 20%, or from about 1% to about 10% by weight based on the total weight of the formulation.

In some embodiments, the amount of polyanion in the nitrapyrin complex can vary. In some embodiments, the amount of polyanion present in the nitrapyrin complex ranges from about 0.01% to about 98%, from about 1 to about 95%, from about 5% to about 85%, from about 10% to about 80%, from about 20% to about 80%, from about 30% to about 80%, from about 40% to about 80%, from about 50% to about 80% or from about 60% to about 80% by weight (or less than about 90%, about 80%, about 70%, about 60%, about 50%, about 40%, about 30%, about 20%, about 10%, about 5%, about 1%, or less than about 0.5% by weight) based on the total weight of the nitrapyrin complex.

In some embodiments, the described nitrapyrin complexes can form solutions that are greater than or equal to 25% nitrapyrin by weight. Suitable solvents include, but are not limited to, aromatic 100, aromatic 200, sulfones, sulfoxides, sulfolanes, amide-containing solvents, fatty acid-based solvents, and glycols.

In some embodiments, the noncorrosive nitrapyrin formulation comprising a nitrapyrin complex reduce volatility of the nitrapyrin by about 1% to about 90%, from about 20% to about 80%, from about 30% to about 70% or from about 40% to about 50% relative to nitrapyrin in formulations that is not complexed to a polyanion. In some embodiments, the noncorrosive nitrapyrin formulation comprising a nitrapyrin complex reduce volatility of the nitrapyrin by about 10% to about 90%, from about 20% to about 90%, from about 30% to about 90%, from about 40% to about 90%, or from about 50% to about 80% relative to nitrapyrin in formulations that is not complexed to a polyanion. In some embodiments, the noncorrosive nitrapyrin formulation comprising a nitrapyrin complex reduce volatility of the nitrapyrin from about from about 5% to about 40% relative to nitrapyrin in formulations that is not complexed to a polyanion. In some embodiments, the noncorrosive nitrapyrin formulation comprising a nitrapyrin complex reduces volatility of the nitrapyrin by about 8% to about 35% relative to nitrapyrin that does not form a complex with a polyanion. In some embodiments, the noncorrosive nitrapyrin formulation comprising a nitrapyrin complex reduce volatility of the nitrapyrin by about 10% to about 30% relative to nitrapyrin that is not complexed with a polyanion. In some embodiments, the noncorrosive formulations comprising a nitrapyrin complex reduce volatility of the nitrapyrin by about 5, 6, 7, 8, 9, 10, 11, 12, 13, 14, 15, 16, 17, 18, 19, 20, 21, 22, 23, 24, 25, 26, 27, 28, or 29% relative to formulations where the nitrapyrin is not complexed with a polyanion.

The noncorrosive nitrapyrin formulation comprising a nitrapyrin complex exhibits significantly lower vapor pressure when compared to nitrapyrin alone or with other formulations. Lower vapor pressure reduces the volatility of the nitrapyrin by at least about 5%, 10%, 15%, 20%, 25%, 30%, 35%, 40%, 45%, 50%, 55%, 60%, 65%, 70%, 75, 80%, 85%, 90%, or at least about 95% compared to nitrapyrin contained in other formulations (e.g., N-Serve and/or Instinct II). Lower vapor pressure also minimizes the loss of nitrapyrin after it has been applied to fields and/or crops thereby providing a longer duration of time where nitrapyrin is effective. In addition, noncorrosive nitrapyrin formulations comprising a nitrapyrin complex can be applied at a significantly lower product application dose rate.

In some embodiments, the disclosed noncorrosive nitrapyrin formulations containing a nitrapyrin complex exhibit reduced corrosion behavior compared to nitrapyrin formulated with other formulations. In some embodiments, noncorrosive nitrapyrin formulations exhibit a reduction in corrosion by at least about 20%, 30%, 40%, 50%, 60%, 70%, 80%, 90%, 95%, or at least 98% compared to nitrapyrin-containing formulations that do not contain nitrapyrin complexed with a polyanion (e.g., N-Serve and/or Instinct II).

### III. Agricultural Products

Any of the described noncorrosive nitrapyrin formulations and compositions thereof can be combined with one or more other ingredients, selected from the group consisting of fertilizer, agriculturally active compounds, seed, compounds having urease inhibition activity, nitrification inhibition activity, one or more biocides (e.g., pesticides, herbicides, insecticides, fungicides, and/or miticides), and the like.

In some embodiments, the described noncorrosive nitrapyrin formulations and compositions thereof may be mixed with the fertilizer products, applied as a surface coating to the fertilizer products, or otherwise thoroughly mixed with the fertilizer products. In some embodiments, in such combined fertilizer/noncorrosive nitrapyrin formulation compositions, the fertilizer is in the form of particles having an average diameter of from about powder size (less than about 0.001 cm) to about 10 mm, more preferably from about 0.1 mm to about 5 mm, and still more preferably from about 0.15 mm to about 3 mm. The nitrapyrin can be present in such combined products at a level of about 0.001 g to about 20 g per 100 g fertilizer, about 0.01 to 7 g per 100 g fertilizer, about 0.08 g to about 5 g per 100 g fertilizer, or about 0.09 g to about 2 g per 100 g fertilizer. In the case of the combined fertilizer/noncorrosive nitrapyrin formulation products, the combined product can be applied at a level so that the amount of nitrapyrin complex applied is about 10-150 g per acre of soil, about 30-125 g per acre of soil, or about 40-120 g per acre of soil. The combined products can likewise be applied as liquid dispersions or as dry granulated products, at the discretion of the user. When noncorrosive nitrapyrin formulations are used as a coating, the noncorrosive nitrapyrin formulations can comprise between about 0.005% and about 15% by weight of the coated fertilizer product, about 0.01% and about 10% by weight of the coated fertilizer product, about 0.05% and about 2% by weight of the coated fertilizer product or about 0.5% and about 1% by weight of the coated fertilizer product.

### A. Fertilizers

In some embodiments, the agricultural product is a fertilizer. The fertilizer can be a solid fertilizer, such as, but not limited to, a granular fertilizer, and the noncorrosive nitrapyrin formulation can be applied to the fertilizer as a liquid dispersion. The fertilizer can be in liquid form, and the noncorrosive nitrapyrin formulation can be mixed with the liquid fertilizer. The fertilizers can be selected from the group consisting of starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing chlorine, fertilizers containing zinc, fertilizers containing manganese, fertilizers containing copper, fertilizers containing urea and ammonium nitrite and/or fertilizers containing molybdenum materials. In some embodiments, the fertilizer is or contains urea and/or ammonia, including anhydrous ammonia fertilizer. In some embodiments, the fertilizer comprises plant-available nitrogen, phosphorous, potassium, sulfur, calcium, magnesium, or micronutrients. In some embodiments, the fertilizer is solid, granular, a fluid suspension, a gas, or a solutionized fertilizer. In some embodiments, the fertilizer comprises a micronutrient. A micronutrient is an essential element required by a plant in small quantities. In some embodiments, the fertilizer comprises a metal ion selected from the group consisting of: Fe, Mn, Mg, Zn, Cu, Ni, Co, Mo, V, and Ca. In some embodiments, the fertilizer comprises gypsum, Kieserite Group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material).

In some embodiments, the noncorrosive nitrapyrin formulation is combined with any suitable liquid or dry fertilizer for application to fields and/or crops.

The described noncorrosive nitrapyrin formulation, or compositions thereof, can be applied with the application of a fertilizer. The noncorrosive nitrapyrin formulation can be applied prior to, subsequent to, or simultaneously with the application of fertilizers.

### B. Seed

Some embodiments describe agricultural seeds coated with one or more of the described noncorrosive nitrapyrin formulations. The noncorrosive nitrapyrin formulations can be present in the seed product at a level of from about 0.001-10%, about 0.004%-2%, about 0.01% to about 1%, or from about 0.1% to about 1% by weight (or no more than about 10%, about 9%, about 8%, about 7% about 6%, about 5%, about 4%, about 3%, about 2%, about 1%, about 0.5%, about 0.1%, about 0.01% or no more than 0.001%), based upon the total weight of the coated seed product. A seed can be, but is not limited to, wheat, barley, oat, triticale, rye, rice, maize, soya bean, cotton, or oilseed rape.

### C. Other

In some embodiments are described urease inhibiting compounds, nitrification inhibiting compounds, biocides (e.g., pesticides, herbicides, insecticides, fungicides, and/or miticides) in combination with one or more of the described noncorrosive nitrapyrin formulations. As used herein, “pesticide” refers to any agent with pesticidal activity (e.g., herbicides, insecticides, and fungicides) and is preferably selected from the group consisting of insecticides, herbicides, and mixtures thereof, but normally excluding materials which assertedly have plant-fertilizing effect, for example, sodium borate and zinc compounds such as zinc oxide, zinc sulfate, and zinc chloride. For an unlimited list of pesticides, see “Farm Chemicals Handbook 2000, 2004” (Meister Publishing Co, Willoughby, OH), which is hereby incorporated by reference in its entirety.

Exemplary herbicides include, but are not limited to, acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester, and the like.

Exemplary insecticides include, but are not limited to, 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A &B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′ DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vamidothion, vaniliprole, XMC, xylylcarb, zeta cypermethrin and zolaprofos.

Exemplary fungicides include, but are not limited to, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, bixafen, blasticidin-S, Bordeaux mixture, boric acid, boscalid, bridged diphenyl fungicides, bromuconazole, bupirimate, Burgundy mixture, buthiobate, sec-butylamine, calcium polysulfide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroform, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, diniconazole-M, dinitrophenol fungicides, dinobuton, dinocap, dinocap-4, dinocap-6, dinocton, dinopenton, dinosulfon, dinoterbon, diphenylamine, dipyrithione, disulfiram, ditalimfos, dithianon, dithiocarbamate fungicides, DNOC, dodemorph, dodicin, dodine, donatodine, drazoxolon, edifenphos, epoxiconazole, etaconazole, etem, ethaboxam, ethirimol, ethoxyquin, ethylene oxide, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, Fluconazole, fludioxonil, flumetover, flumorph, fluopicolide, fluoroimide, fluotrimazole, fluoxastrobin, fluquinconazole, flusilazole, flusulfamide, flutolanil, flutriafol, fluxapyroxad, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isopropyl alcohol, isoprothiolane, isovaledione, isopyrazam, kasugamycin, ketoconazole, kresoxim-methyl, lime sulfur (lime sulphur), mancopper, mancozeb, maneb, mebenil, mecarbinzid, mepanipyrim, mepronil, mercuric chloride (obsolete), mercuric oxide (obsolete), mercurous chloride (obsolete), metalaxyl, metalaxyl-M (a.k.a. Mefenoxam), metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylmercury)-p-toluenesulfonanilide, nabam, natamycin, nystatin, β-nitrostyrene, nitrothal-isopropyl, nuarimol, OCH, octhilinone, ofurace, oprodione, organomercury fungicides, organophosphorus fungicides, organotin fungicides (obsolete), orthophenyl phenol, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulfamide fungicides, phosdiphen, phosphite, phthalide, phthalimide fungicides, picoxystrobin, piperalin, polycarbamate, polymeric dithiocarbamate fungicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfur, pyrrole fungicides, quinacetol, quinazamid, quinconazole, quinoline fungicides, quinomethionate, quinone fungicides, quinoxaline fungicides, quinoxyfen, quintozene, rabenzazole, salicylanilide, silthiofam, silver, simeconazole, sodium azide, sodium bicarbonate[2][3], sodium orthophenylphenoxide, sodium pentachlorophenoxide, sodium polysulfide, spiroxamine, streptomycin, strobilurin fungicides, sulfonanilide fungicides, sulfur, sulfuryl fluoride, sultropen, TCMTB, tebuconazole, tecloftalam, tecnazene, tecoram, tetraconazole, thiabendazole, thiadifluor, thiazole fungicides, thicyofen, thifluzamide, thymol, triforine, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, undecylenic acid, uniconazole, uniconazole-P, urea fungicides, validamycin, valinamide fungicides, vinclozolin, voriconazole, zarilamid, zinc naphthenate, zineb, ziram, and/or zoxamide.

In some embodiments, the composition of the presently disclosed subject matter is a pesticide/noncorrosive nitrapyrin formulation-containing composition comprising a pesticide and a noncorrosive nitrapyrin formulation. In some embodiments, the pesticide is an herbicide, insecticide, or a combination thereof.

In some embodiments, the composition of the presently disclosed subject matter is a fungicide/noncorrosive nitrapyrin formulation-containing composition comprising a fungicide and a noncorrosive nitrapyrin formulation.

The amount of noncorrosive nitrapyrin formulation in the pesticide/noncorrosive nitrapyrin formulation-containing composition and/or fungicide/noncorrosive nitrapyrin formulation-containing composition can vary. In some embodiments, the amount of noncorrosive nitrapyrin formulation is present at a level of from about 0.05-10% by weight (more preferably from about 0.1%-4% by weight, and most preferably from about 0.2-2% by weight) based upon the total weight of the pesticide/noncorrosive nitrapyrin formulation-containing composition or fungicide/noncorrosive nitrapyrin formulation-containing composition taken as 100% by weight Exemplary classes of miticides include, but are not limited to, botanical acaricides, bridged diphenyl acaricides, carbamate acaricides, oxime carbamate acaricides, carbazate acaricides, dinitrophenol acaricides, formamidine acaricides, isoxaline acaricides, macrocyclic lactone acaricides, avermectin acaricides, milbemycin acaricides, milbemycin acaricides, mite growth regulators, organochlorine acaricides, organophosphate acaricides, organothiophosphate acaricides, phosphonate acaricides, phosphoarmidothiolate acaricies, organitin acaricides, phenylsulfonamide acaricides, pyrazolecarboxamide acaricdes, pyrethroid ether acaricide, quaternary ammonium acaricides, oyrethroid ester acaricides, pyrrole acaricides, quinoxaline acaricides, methoxyacrylate strobilurin acaricides, teronic acid acaricides, thiasolidine acaricides, thiocarbamate acaricides, thiourea acaricides, and unclassified acaricides. Examples of miticides for these classes include, but are not limited to, to botanical acaricides—carvacrol, sanguinarine; bridged diphenyl acaricides—azobenzene, benzoximate, benzyl, benzoate, bromopropylate, chlorbenside, chlorfenethol, chlorfenson, chlorfensulphide, chlorobenzilate, chloropropylate, cyflumetofen, DDT, dicofol, diphenyl, sulfone, dofenapyn, fenson, fentrifanil, fluorbenside, genit, hexachlorophene, phenproxide, proclonol, tetradifon, tetrasul; carbamate acaricides—benomyl, carbanolate, carbaryl, carbofuran, methiocarb, metolcarb, promacyl, propoxur; oxime carbamate acaricides—aldicarb, butocarboxim, oxamyl, thiocarboxime, thiofanox; carbazate acaricides—bifenazate; dinitrophenol acaricides—binapacryl, dinex, dinobuton, dinocap, dinocap-4, dinocap-6, dinocton, dinopenton, dinosulfon, dinoterbon, DNOC; formamidine acaricides—amitraz, chlordimeform, chloromebuform, formetanate, formparanate, medimeform, semiamitraz; isoxazoline acaricides—afoxolaner, fluralaner, lotilaner, sarolaner; macrocyclic lactone acaricides—tetranactin; avermectin acaricides—abamectin, doramectin, eprinomectin, ivermectin, selamectin; milbemycin acaricides—milbemectin, milbemycin, oxime, moxidectin; mite growth regulators—clofentezine, cyromazine, diflovidazin, dofenapyn, fluazuron, flubenzimine, flucycloxuron, flufenoxuron, hexythiazox; organochlorine acaricides—bromociclen, camphechlor, DDT, dienochlor, endosulfan, lindane; organophosphate acaricides-chlorfenvinphos, crotoxyphos, dichlorvos, heptenophos, mevinphos, monocrotophos, naled, TEPP, tetrachlorvinphos; organothiophosphate acaricides—amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, ethion, ethoate-methyl, formothion, malathion, mecarbam, methacrifos, omethoate, oxydeprofos, oxydisulfoton, parathion, phenkapton, phorate, phosalone, phosmet, phostin, phoxim, pirimiphos-methyl, prothidathion, prothoate, pyrimitate, quinalphos, quintiofos, sophamide, sulfotep, thiometon, triazophos, trifenofos, vamidothion; phosphonate acaricides—trichlorfon; phosphoramidothioate acaricides—isocarbophos, methamidophos, propetamphos; phosphorodiamide acaricides—dimefox, mipafox, schradan; organotin acaricides—azocyclotin, cyhexatin, fenbutatin, oxide, phostin; phenylsulfamide acaricides—dichlofluanid; phthalimide acaricides—dialifos, phosmet; pyrazole acaricides—cyenopyrafen, fenpyroximate; phenylpyrazole acaricides—acetoprole, fipronil, vaniliprole; pyrazolecarboxamide acaricides—pyflubumide, tebufenpyrad; pyrethroid ester acaricides—acrinathrin, bifenthrin, brofluthrinate, cyhalothrin, cypermethrin, alpha-cypermethrin, fenpropathrin, fenvalerate, flucythrinate, flumethrin, fluvalinate, tau-fluvalinate, permethrin; pyrethroid ether acaricides—halfenprox; pyrimidinamine acaricides—pyrimidifen; pyrrole acaricides—chlorfenapyr; quaternary ammonium acaricides—sanguinarine; quinoxaline acaricides—chinomethionat, thioquinox; methoxyacrylate strobilurin acaricides—bifujunzhi, fluacrypyrim, flufenoxystrobin, pyriminostrobin; sulfite ester acaricides—aramite, propargite; tetronic acid acaricides—spirodiclofen; tetrazine acaricides, clofentezine, diflovidazin; thiazolidine acaricides—flubenzimine, hexythiazox; thiocarbamate acaricides—fenothiocarb; thiourea acaricides—chloromethiuron, diafenthiuron; unclassified acaricides—acequinocyl, acynonapyr, amidoflumet, arsenous, oxide, clenpirin, closantel, crotamiton, cycloprate, cymiazole, disulfiram, etoxazole, fenazaflor, fenazaquin, fluenetil, mesulfen, MNAF, nifluridide, nikkomycins, pyridaben, sulfiram, sulfluramid, sulfur, thuringiensin, triarathene.

In some embodiments, a miticide can also be selected from abamectin, acephate, acequinocyl, acetamiprid, aldicarb, allethrin, aluminum phosphide, aminocarb, amitraz, azadiractin, azinphos-ethyl, azinphos-methyl, Bacillus thuringiensis, bendiocarb, beta-cyfluthrin, bifenazate, bifenthrin, bomyl, buprofezin, calcium cyanide, carbaryl, carbofuran, carbon disulfide, carbon tetrachloride, chlorfenvinphos, chlorobenzilate, chloropicrin, chlorpyrifos, clofentezine, chlorfenapyr, clothianidin, coumaphos, crotoxyphos, crotoxyphos+dichlorvos, cryolite, cyfluthrin, cyromazine, cypermethrin, deet, deltamethrin, demeton, diazinon, dichlofenthion, dichloropropene, dichlorvos, dicofol, dicrotophos, dieldrin, dienochlor, diflubenzuron, dikar (fungicide+miticide), dimethoate, dinocap, dinotefuran, dioxathion, disulfoton, emamectin benzoate, endosulfan, endrin, esfenvalerate, ethion, ethoprop, ethylene dibromide, ethylene dichloride, etoxazole, famphur, fenitrothion, fenoxycarb, fenpropathrin, fenpyroximate, fensulfothion, fenthion, fenvalerate, flonicamid, flucythrinate, fluvalinate, fonofos, formetanate hydrochloride, gamma-cyhalothrin, halofenozide, hexakis, hexythiazox, hydramethylnon, hydrated lime, indoxacarb, imidacloprid, kerosene, kinoprene, lambda-cyhalothrin, lead arsenate, lindane, malathion, mephosfolan, metaldehyde, metam-sodium, methamidophos, methidathion, methiocarb, methomyl, methoprene, methoxychlor, methoxyfenozide, methyl bromide, methyl parathion, mevinphos, mexacarbate, Milky Disease Spores, naled, naphthalene, nicotine sulfate, novaluron, oxamyl, oxydemeton-methyl, oxythioquinox, para-dichlorobenzene, parathion, PCP, permethrin, petroleum oils, phorate, phosalone, phosfolan, phosmet, phosphamidon, phoxim, piperonyl butoxide, pirimicarb, pirimiphos-methyl, profenofos, propargite, propetamphos, propoxur, pymetrozine, pyrethroids—synthetic: see allethrin, permethrin, fenvalerate, resmethrin, pyrethrum, pyridaben, pyriproxyfen, resmethrin, rotenone, s-methoprene, soap, pesticidal, sodium fluoride, spinosad, spiromesifen, sulfotep, sulprofos, temephos, terbufos, tetrachlorvinphos, tetrachlorvinphos+dichlorvos, tetradifon, thiamethoxam, thiodicarb, toxaphene, tralomethrin, trimethacarb, and tebufenozide.

### IV. Methods

In some embodiments, the noncorrosive nitrapyrin formulations are formulated in ways to make their use convenient in the context of productive agriculture. The noncorrosive nitrapyrin formulations used in these methods include nitrapyrin complexes as described above. The noncorrosive nitrapyrin formulations can be used in methods such as:
A. Methods of Improving Plant Growth and/or Fertilizing Soil
B. Methods of Inhibiting Nitrification or Ammonia Release or Evolution
C. Methods of Reducing Nitrapyrin Volatilization
D. Methods of Improving Soil Conditions
E. Methods of Preparing a Noncorrosive Nitrapyrin Formulation

A. Methods for improving plant growth comprise contacting a noncorrosive nitrapyrin formulation or a composition thereof as disclosed herein with soil. In some embodiments, the noncorrosive nitrapyrin formulation or composition is applied to the soil prior to emergence of a planted crop. In some embodiments, the noncorrosive nitrapyrin formulation is applied to the soil adjacent to the plant and/or at the base of the plant and/or in the root zone of the plant.

Methods for improving plant growth can also be achieved by applying a noncorrosive nitrapyrin formulation or a composition thereof as a seed coating to a seed in the form of a liquid dispersion, which upon drying forms a dry residue. In these embodiments, seed coating provides the noncorrosive nitrapyrin formulation in close proximity to the seed when planted so that the nitrapyrin complex can exert its beneficial effects in the environment where it is most needed. That is, noncorrosive nitrapyrin formulation provides an environment conducive to enhanced plant growth in the area where the effects can be localized around the desired plant. In the case of seeds, the coating containing the noncorrosive nitrapyrin formulation provides an enhanced opportunity for seed germination, subsequent plant growth, and an increase in plant nutrient availability.

B. Methods for inhibiting/reducing nitrification or ammonia release or evolution in an affected area comprises applying a noncorrosive nitrapyrin formulation or composition thereof to the affected area. The affected area may be soil adjacent to a plant, a field, a pasture, a livestock or poultry confinement facility, pet litter, a manure collection zone, upright walls forming an enclosure, or a roof substantially covering the area, and in such cases the noncorrosive nitrapyrin formulation may be applied directly to the manure in the collection zone. The noncorrosive nitrapyrin formulation is preferably applied at a level from about 0.005-3 gallons per ton of manure, in neat form or in the form of an aqueous dispersion having a pH from about 1-5.

C. Methods of reducing nitrapyrin volatilization comprise mixing the nitrapyrin with a polyanion thereby forming a nitrapyrin complex. Nitrapyrin complexes are less volatile compared to the nitrapyrin-free base. In some embodiments, noncorrosive formulation as disclosed herein containing nitrapyrin complexes reduce volatility by about 5% to about 40%, about 8% to about 35%, or about 10% to about 30% (or by about 5, 6, 7, 8, 9, 10, 11, 12, 13, 14, 15, 16, 17, 18, 19, 20, 21, 22, 23, 24, 25, 26, 27, 28, or 29%) relative to nitrapyrin and formulations thereof wherein the nitrapyrin is not complexed with a polyanion.

D. Methods for improving soil conditions selected from the group consisting of nitrification processes, urease activities, and combinations thereof, comprising the step of applying to soil an effective amount of a described noncorrosive nitrapyrin formulation or composition thereof. In some embodiments, the noncorrosive nitrapyrin formulation is mixed with an ammoniacal solid, liquid, or gaseous fertilizer, and especially solid fertilizers; in the latter case, the noncorrosive nitrapyrin formulation is applied to the surface of the fertilizer as an aqueous dispersion followed by drying, so that nitrapyrin-organic acid ionic mixture is present on the solid fertilizer as a dried residue. The noncorrosive nitrapyrin formulation is generally applied at a level of from about 0.01-10% by weight, based upon the total weight of the noncorrosive nitrapyrin formulation/fertilizer product taken as 100% by weight. Where the fertilizer is an aqueous liquid fertilizer, the noncorrosive nitrapyrin formulation is added thereto with mixing. The noncorrosive nitrapyrin formulation is in neat form or is in aqueous dispersion and have a pH of up to about 3.

E. Methods of preparing a noncorrosive nitrapyrin formulation comprise adding an amine-based corrosion inhibitor to an organic solvent to form a first mixture; contacting the first mixture with nitrapyrin to form a second mixture; and optionally contacting the second mixture with a polyanion to render a third mixture. In some embodiments, additives such as surface active gents, antifoam agents, and/or dispersants are added to the third mixture. For embodiments where no organic solvent is required, the amine-based corrosion inhibitor is contacted directly with the nitrapyrin-containing agent to form the noncorrosive nitrapyrin formulation.

F. Methods of reducing corrosion of metal-based materials used in agricultural equipment comprising: obtaining a noncorrosive nitrapyrin formulation as disclosed herein; and contacting a metal surface with the non-corrosive nitrapyrian formulation for a period of time. In some embodiments, the metal surface is a portion of an agricultural equipment. In some embodiments, the metal surface contains aluminum, mild steel, carbon steel, iron, carbon steel, steel alloys, or a combination thereof. In such methods, the amount of corrosion of the metal-based material is less than the amount of corrosion of a metal-based material that has been in contract with a nitrapyrin-containing composition not containing a corrosion inhibitor composition as disclosed herein. In some embodiments, the noncorrosive nitrapyrin formulation inhibits corrosion of a metal-based material by at least 5%, 10%, 15%, 20%, 25%, 30%, 35%, 40%, 45%, 50%, 55%, 60%, 65%, 70%, 75%, 80%, 85%, 90%, 95%, 98%, or at least 99% compared to nitrapyrin-containing formulations that do not contain a corrosion inhibitor composition as disclosed herein. In some embodiments, the noncorrosive nitrapyrin formulation inhibits corrosion of a metal-based material in an amount of from about 20% to about 99%, from about 30% to about 99%, from about 50% to about 99%, from about 60% to about 99%, from about 75% to about 99%, from about 85% to about 99%, or from about 90% to about 99% compared to nitrapyrin-containing formulations that do not contain a corrosion inhibitor composition as disclosed herein.

In some embodiments, the time between the obtaining step and the contacting step can vary. In some embodiments, the obtaining step and the contacting step are carried out within about 24 hours, about 20 hours, about 15 hours, about 10 hours, about 5 hours, about 3 hours, or about 1 hour.

In some embodiments, the contact time between the noncorrosive formulation and the surface of the metal-based material varies. In some embodiments, the contact time between the noncorrosive formulation and the surface ranges from about 1 minute to about 24h, from about 1 hour to about 20h, from about 5 hours to about 15, or from about 7 hours to about hours. In some embodiments, the contact time is less than about 24 hours. In some embodiments, the contact time is less than 1 hour.

In some embodiments, the temperature of the contacting step can vary. In some embodiments, the temperature at which the contacting step occurs ranges from about −20° C. to about 40° C.

In some embodiments, the methods A, B, and D above comprise contacting a desired area with a noncorrosive nitrapyrin formulation at a rate of about 100 g to about 120 g per acre of the noncorrosive nitrapyrin formulation. The noncorrosive nitrapyrin formulation can, in some embodiments, be in solution at an amount of about 0.5 lbs to about 4 lbs per U.S. gallon, or from about 1 lb to about 3 lbs/per U.S. gallon, or about 2 lbs per U.S. gallon. In some embodiments, the method includes contacting the desired area at a rate of about 0.5 to about 4 qt/A, or about 1 to about 2 qt/A.

### Examples

It should be understood that the following examples are provided by way of illustration only and nothing therein should be taken as a limiting.

### Example 1. Decreased Volatility of Nitrapyrin/Polyanionic Polymer Salts

Three materials were placed on a heated balance at 100% C and had their weights observed every minute for 10 minutes, as a percent of original weight. The materials were:
1. pure nitrapyrin,
2. 25% w/w solution of nitrapyrin in sulfolane, and
3. solution of 25% nitrapyrin salt with equimolar (on acid basis) amount of maleic-itaconic copolymer, also in sulfolane (nitrapyrin/polyanionic polymer salt).

The weight loss data in Tables 2-3 show that ionic mixtures of nitrapyrin and an organic acid exhibited significantly decrease rate of nitrapyrin loss as compared to free nitrapyrin, both as a solution and as free nitrapyrin. The data show a 10-30% reduction in volatilization of the nitrapyrin when used as part of an ionic mixture compared to untreated. Therefore, the disclosed nitrapyrin-organic acid ionic mixtures substantially reduce the volatilization of nitrapyrin.

TABLE 2
Nitrapyrin volatilization from 25% w/w actives sulfolane solution formulations at 100° C.

| | nitrapyrin | % per | % of | nitrapyrin | % per | % | % increase in | |
|---|---|---|---|---|---|---|---|---|
| | solution | minute | original | polyanionic | minute | original | volatility of | nitrapyrin |
| Experiment | (no | loss rate | nitrapyrin | polymer salt | loss rate | nitrapyrin | nitrapyrin | without |
| time, min. | polymer) | untreated | lost | solution | treated | lost | solution | solvent |
| 0 | 100.00% | preheat | | 100.15% | preheat | | preheat | 100.00% |
| 1 | 99.75% | | | 99.54% | | | | 99.20% |
| 2 | 99.26% | | | 98.32% | | | | 98.56% |
| 3 | 98.15% | | | 96.85% | | | | 97.92% |
| 4 | 97.29% | 0.86% | 3.44% | 96.49% | 0.36% | 1.44% | 139% | 96.00% |
| 5 | 96.19% | 1.10% | 4.40% | 95.88% | 0.61% | 2.44% | 80% | 94.87% |
| 6 | 95.57% | 0.62% | 2.48% | 95.27% | 0.61% | 2.44% | 2% | 93.75% |
| 7 | 94.71% | 0.86% | 3.44% | 94.50% | 0.77% | 3.08% | 12% | 92.63% |
| 8 | 93.85% | 0.86% | 3.44% | 93.74% | 0.76% | 3.04% | 13% | 90.87% |
| 9 | 93.23% | 0.62% | 2.48% | 93.13% | 0.61% | 2.44% | 2% | 89.90% |
| 10 | 92.50% | 0.73% | 2.92% | 92.52% | 0.61% | 2.44% | 20% | 89.10% |
| Delta 3-10 | 5.65% | 0.81% | | 4.33% | 0.62% | | 30% | |
| Delta 4-10 | 4.79% | 0.68% | | 3.97% | 0.57% | | 21% | |
| Delta 5-10 | 3.69% | 0.53% | | 3.36% | 0.48% | | 10% | |
| Cumulative | | | 22.60% | | | 17.32% | | |
| 3-10 | | | | | | | | |
| Cumulative | | | 19.16% | | | 15.88% | | |
| 4-10 | | | | | | | | |
| Cumulative | | | 14.76% | | | 13.44% | | |
| 5-10 | | | | | | | | |

* % increase in volatility of nitrapyrin solution compared to nitrapyrin polyanionic salt solution agricultural carrier.

Tests were run to determine the relative volatility of the nitrapyrin solution without polyanionic polymer.

TABLE 3

| | | | nitrapyrin | nitrapyrin | nitrapyrin polymer |
|---|---|---|---|---|---|
| Experiment | nitrapyrin | | sulfolane | solution | salt solution |
| time, | without | Solvent | volatility | volatility rate vs. | volatility rate vs. |
| min. | solvent | alone | ratio | solvent alone * | solvent alone |
| 0 | 100.00% | 100.0% | | | |
| 1 | 99.20% | 99.85% | | | |
| 2 | 98.56% | 99.56% | | | |
| 3 | 97.92% | 98.68% | | | |
| 4 | 96.00% | 98.24% | | | |
| 5 | 94.87% | 97.95% | | | |
| 6 | 93.75% | 97.51% | | | |
| 7 | 92.63% | 97.51% | | | |
| 8 | 90.87% | 97.07% | | | |
| 9 | 89.90% | 96.77% | | | |
| 10 | 89.10% | 96.48% | | | |
| Delta 3-10 | | | 401% | 527% | 197% |
| Delta 4-10 | | | 392% | 272% | 226% |
| Delta 5-10 | | | 393% | 251% | 229% |
| Cumulative 3-10 | | | | | |
| Cumulative 4-10 | | | | | |
| Cumulative 5-10 | | | | | |

* The nitrapyrin solution (without polyanionic polymer) is more volatile than solvent alone.

### Example 2. Formation of Solutions of Nitrapyrin Salts and Grading of Solutions

TABLE 4
Nitrapyrin salt solutions containing 20% nitrapyrin

| | | MW (per | | g polyanion | |
|---|---|---|---|---|---|
| | | repeat unit), | MW/ | to react 1:1 | |
| | # anionic | corrected for | charged | with 2.00 g | g solvent to |
| | groups | conc. | group | nitrapyrin | be used* |
| malic | 2 | 134 | 67 | 0.580 | 7.420 |
| tartaric | 2 | 150 | 75 | 0.649 | 7.351 |
| etidronic | 4 | 343 | 86 | 0.742 | 7.258 |
| succinic | 2 | 118 | 59 | 0.511 | 7.489 |
| adipic | 2 | 146 | 73 | 0.632 | 7.368 |
| sebacic | 2 | 202 | 101 | 0.874 | 7.126 |
| isophthalic | 2 | 166 | 83 | 0.719 | 7.281 |
| maleic- | 1 | 126 | 126 | 1.091 | 6.909 |
| acrylic | | | | | |
| copolymer | | | | | |
| BC | 1 | 103 | 103 | 0.892 | 7.108 |
| T5 | 1 | 107 | 107 | 0.926 | 7.074 |

*Dipropylene glycol, Dow PT250, Dow PT700, triethylene glycol, tripropylene glycol, propylene carbonate, triacetin, Agnique AMD810, Agnique AMD3L, Rhodiasolv ADMA10, Rhodiasolv ADMA810, Rhodiasolv PolarClean. Solvents which can be used to dissolve a nitrapyrin-organic acid ionic mixture include, but are not limited to: aromatic solvents, particularly alkyl substituted benzenes such as xylene or propylbenzene fractions, and mixed naphthalene and alkyl naphthalene fractions; mineral oils; kerosene; dialkyl amides of fatty acids, particularly the dimethylamides of fatty acids such as the dimethyl amide of caprylic acid; chlorinated aliphatic and aromatic hydrocarbons such as 1,1,1-trichloroethane and chlorobenzene, esters of glycol derivatives, such as the acetate of the n-butyl, ethyl, or methyl ether of diethyleneglycol and the acetate of the methyl ether of dipropylene glycol; ketones such as isophorone and trimethylcyclohexanone (dihydroisophorone); and the acetate products such as hexyl or heptyl acetate.

TABLE 5
Component Calculations and Solvent Density

| | |
|---|---|
| Nitrapyrin, moles in 2.00 g | 0.00866 |
| BC acid density, g/ml, est. | 1.23 |
| T5 acid density, g/ml, est. | 1.20 |
| Maleic-acrylic density, g/ml | 1.23 |
| Dipropylene glycol | 1.02 g/ml |
| PT700 | 1.03 g/ml |
| PT250 | 1.09 g/ml |
| Triethylene glycol | 1.13 g/ml |
| Tripropylene glycol | 1.02 g/ml |
| Propylene carbonate | 1.21 g/ml |
| Triacetin | 1.16 g/ml |
| Agnique AMD810 | 0.88 g/ml |
| Agnique AMD3L | 1.05 g/ml |
| Rhodiasolv ADMA10 | 0.88 g/ml |
| Rhodiasolv ADM810 | 0.88 g/ml |
| Rhodiasolv PolarClean | 1.04 g/ml |

TABLE 6
Grading Scale of Solutions

| | |
|---|---|
| Fully dissolved | 5 |
| Mostly dissolved | 4 |
| Mostly not dissolved | 3 |
| Not dissolved | 2 |
| Additional precipitate | 1 |

TABLE 7
Solvent Acid Combination Table; results for reaction at 20% w/w nitrapyrin

| | | Solvent | | | | | | | | | | | |
|---|---|---|---|---|---|---|---|---|---|---|---|---|---|
| | | dipro- | | | tri- | tripro- | pro- | | | | | | |
| | | pylene | | | ethylene | pylene | pylene | tri- | Agnique | Agnique | Rhodiasolv | Rhodiasolv | Rhodiasolv |
| | | glycol | PT700 | PT250 | glycol | glycol | carbonate | acetin | AMD810 | AMD3L | ADMA10 | ADMA810 | PolarClean |
| Acid | | A | B | C | D | E | F | G | H | I | J | K | L |
| malic | 1 | 2 | 4 | 1 | 2 | 2 | 3 | 3 | 5 | 5 | 5 | 5 | 5 |
| tartaric | 2 | 2 | 2 | 1 | 1 | 2 | 2 | 2 | 5 | 5 | 5 | 5 | 5 |
| etidronic | 3 | 1 | 4 | 1 | 1 | 1 | 2 | 2 | 4 | 5 | 5 | 4 | 5 |
| succinic | 4 | 3 | 4 | 1 | 2 | 3 | 3 | 2 | 5 | 5 | 5 | 5 | 5 |
| adipic | 5 | 2 | 3 | 1 | 3 | 4 | 3 | 3 | 5 | 5 | 5 | 5 | 5 |
| sebaric | 6 | 1 | 2 | 1 | 2 | 1 | 2 | 2 | 3 | 5 | 2 | 4 | 5 |
| isophthalic | 7 | 2 | 2 | 1 | 1 | 4 | 3 | 3 | 3 | 3 | 3 | 3 | 3 |
| maleic- | 8 | 1 | 2 | 1 | 1 | 1 | 2 | 2 | 5 | 5 | 5 | 5 | 5 |
| acrylic | | | | | | | | | | | | | |
| copolymer | | | | | | | | | | | | | |
| BC | 9 | 1 | 4 | 1 | 1 | 1 | 2 | 2 | 5 | 5 | 5 | 5 | 5 |
| T5 | 10 | 1 | 2 | 1 | 1 | 1 | 2 | 2 | 3 | 5 | 3 | 4 | 5 |

TABLE 8
Solvent acid combination, solvent volumes, 8x pipetting

| | | Solvent | | | | | | | | | | | |
|---|---|---|---|---|---|---|---|---|---|---|---|---|---|
| | | dipro- | | | tri- | tripro- | pro- | | | | | | |
| | | pylene | | | ethylene | pylene | pylene | tri- | Agnique | Agnique | Rhodiasolv | Rhodiasolv | Rhodiasolv |
| | | glycol | PT700 | PT250 | glycol | glycol | carbonate | acetin | AMD810 | AMD3L | ADMA10 | ADMA810 | PolarClean |
| Acid | | A | B | C | D | E | F | G | H | I | J | K | L |
| malic | 1 | 0.909 | 0.900 | 0.851 | 0.821 | 0.909 | 0.767 | 0.800 | 1.054 | 0.883 | 1.054 | 1.054 | 0.892 |
| tartaric | 2 | 0.901 | 0.892 | 0.843 | 0.813 | 0.901 | 0.759 | 0.792 | 1.044 | 0.875 | 1.044 | 1.044 | 0.883 |
| etidronic | 3 | 0.889 | 0.881 | 0.832 | 0.803 | 0.889 | 0.750 | 0.782 | 1.031 | 0.864 | 1.031 | 1.031 | 0.872 |
| succinic | 4 | 0.918 | 0.909 | 0.859 | 0.828 | 0.918 | 0.774 | 0.807 | 1.064 | 0.892 | 1.064 | 1.064 | 0.900 |
| adipic | 5 | 0.903 | 0.894 | 0.845 | 0.815 | 0.903 | 0.761 | 0.794 | 1.047 | 0.877 | 1.047 | 1.047 | 0.886 |
| sebaric | 6 | 0.873 | 0.865 | 10.817 | 0.788 | 0.873 | 0.736 | 0.768 | 1.012 | 0.848 | 1.012 | 1.012 | 0.856 |
| isophthalic | 7 | 0.892 | 0.884 | 0.835 | 0.805 | 0.892 | 0.752 | 0.785 | 1.034 | 0.867 | 1.034 | 1.034 | 0.875 |
| maleic- | 8 | 0.847 | 0.838 | 0.792 | 0.764 | 0.847 | 0.714 | 0.745 | 0.981 | 0.823 | 0.981 | 0.981 | 0.830 |
| acrylic | | | | | | | | | | | | | |
| copolymer | | | | | | | | | | | | | |
| BC | 9 | 0.871 | 0.863 | 0.815 | 0.786 | 0.871 | 0.734 | 0.766 | 1.010 | 0.846 | 1.010 | 1.010 | 0.854 |
| T5 | 10 | 0.867 | 0.858 | 0.811 | 0.782 | 0.867 | 0.731 | 0.762 | 1.005 | 0.842 | 1.005 | 1.005 | 0.850 |

All technical and scientific terms used herein have the same meaning. Efforts have been made to ensure accuracy with respect to numbers used (e.g., amounts, temperature, etc.) but some experimental errors and deviations should be accounted for.

Throughout this specification and the claims, the words “comprise,” “comprises,” and “comprising” are used in a nonexclusive sense, except where the context requires otherwise. It is understood that embodiments described herein include “consisting of” and/or “consisting essentially of” embodiments.

As used herein, the term “about,” when referring to a value is meant to encompass variations of, in some embodiments ±5%, in some embodiments ±1%, in some embodiments ±0.5%, and in some embodiments ±0.1% from the specified amount, as such variations are appropriate to perform the disclosed methods or employ the disclosed compositions.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers is also encompassed, subject to any specifically excluded limit in the stated range. Where the stated range includes one or both of the limits, ranges excluding either or both of those included limits are also included.

Many modifications and other embodiments set forth herein will come to mind to one skilled in the art to which this subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

1. A noncorrosive nitrapyrin formulation comprising:
a nitrapyrin complex comprising nitrapyrin complexed with a polyanion;
an amine-based corrosion inhibitor selected from a neutralizing amine, a film-forming amine and a combination thereof; and
an organic solvent,
wherein the non-polymeric polyanion comprises a mono, di-, tri-, tetra-, penta-, hexa-, hepta-, octa-, nona-, or deca-carboxyl, a di-, tri-, tetra-, penta-, hexa-, hepta-, octa-, nona-, or deca-sulfonate, or a di-, tri-, tetra-, penta-, hexa-, hepta-, octa-, nona-, or deca-phosphonate.

2. (canceled)

3. (canceled)

4. (canceled)

5. The formulation of claim 1, wherein where the polyanionic polymer comprises a random copolymer having at least two repeat units including at least one each of type B and type C repeat unites, and optionally one or more different type G repeat units, wherein
a) the type B repeat units are independently selected from the group consisting of repeat units derived from substituted and unsubstituted monomers of maleic acid, maleic anhydride, fumaric acid, fumaric anhydride, mesaconic acid, mesaconic, mixtures of the foregoing, and any isomers, esters, acid chlorides, and partial or complete salts of any of the foregoing, wherein type B repeat units may be substituted with one or more C1-C6 straight or branched chain alkyl groups substantially free of ring structures and halo atoms, and wherein the salts have salt-forming cations selected from the group consisting of metals, amines, and mixtures thereof,
b) the type C repeat units selected from the group consisting of repeat units derived from substituted or unsubstituted monomers of itaconic acid, itaconic anhydride, and any isomers, esters, and the partial or complete salts of any of the foregoing, and mixtures of any of the foregoing, wherein the type C repeat units may be substituted with one or more C1-C6 straight or branched chain alkyl groups substantially free of ring structures and halo atoms, and wherein the salts have salt-forming cations selected from the group consisting of metals, amines, and mixtures thereof, and
c) the type G repeat units selected from the group consisting of repeat units derived from substituted or unsubstituted sulfonated monomers possessing at least one carbon-carbon double bond and at least one sulfonate group and which are substantially free of aromatic rings and amide groups, and any isomers, and the partial or complete salts of any of the foregoing, and mixtures of any of the foregoing, wherein type G repeat units may be substituted with one or more C1-C6 straight or branched chain alkyl groups substantially free of ring structures and halo atoms, and wherein the salts of the type G repeat units have salt-forming cations selected from the group consisting of metals, amines, and mixtures thereof, and wherein at least about 90 mole percent of the repeat units therein are selected from the group consisting of type B, C, and G repeat units, and mixtures thereof, and, wherein the polyanionic polymer contains no more than about 10 mole percent of any of (i) non-carboxylate olefin repeat units, (ii) ether repeat units, and (iii) non-sulfonated monocarboxylic repeat units.

6. The formulation of claim 5, wherein the polyanionic polymer consists of one type B repeat unit derived from maleic acid, one type C repeat unit derived from itaconic acid, and two type G repeat units respectively derived from methallylsulfonic acid and allylsulfonic acid.

7. The formulation of claim 5, wherein the polyanionic polymer has a repeat unit molar composition of:
1-70 mole percent type B repeat units, 1-80 mole percent type C repeat units, and 0.1-65 mole percent type G repeat units; or
20-65 mole percent type B repeat units, 15-75 mole percent type C repeat units, and 1-35 mole percent type G repeat units; or
35-55 mole percent type B repeat units, 20-55 mole percent type C repeat units, and 1-25 mole percent methallylsulfonic repeat units, and 1-20 mole percent allylsulfonic repeat units.

8. The formulation of claim 5, wherein the polyanionic polymer has a repeat unit molar composition of:
about 45 mole percent maleic repeat units, about 50 mole percent itaconic repeat units, about 4 mole percent methallylsulfonic repeat units, and about 1 mole percent allylsulfonic repeat units; or
about 45 mole percent maleic repeat units, about 35 mole percent itaconic repeat units, about 15 mole percent methallylsulfonate repeat units, and about 5 mole percent allylsulfonate repeat units.

9. (canceled)

10. The formulation of claim 5, wherein the polyanionic polymer is a copolymer consisting of maleic and itaconic repeat units.

11. The formulation of claim 5, wherein the polyanionic polymer is a T5 polymer.

12. (canceled)

13. (canceled)

14. (canceled)

15. (canceled)

16. (canceled)

17. (canceled)

18. The formulation of claim 1, wherein the polyanion is present at a loading/concentration from about 50% to about 80% wt/wt based on the total weight of the nitrapyrin complex; and/or nitrapyrin is present at a loading/concentration from about 20% to about 50% wt/wt based on the total weight of the formulation.

19. (canceled)

20. (canceled)

21. The formulation of claim 1, wherein the neutralizing amine is selected from the group consisting of cyclohexylamine (CHA), methoxypropylamine (MPA), monoethanolamine (MEA), morpholine (MOR), 3-methoxypropylamine (MOPA), ethylamine (ET), dimethylamine (DMA), 1,8-dia 1,8-Diazabicyclo(5.4.0)undec-7-ene (DBU), 2-diethylaminoethanol (DEAE), ethanolamine (ETA), diethanolamine (DEA), diethylhydroxylamine (DEHA), methyldiethanolamine (MDEA), and a combination thereof.

22. The formulation of claim 1, wherein the film-forming amine is a fatty amine of formula (I):
R₁—[NH—R₂]ₙ—NH₂
wherein n is an integer between 0 and 7,
R₁ is a substituted or unsubstituted (C₁₀-C₂₂) alkyl group, and
R₂ is a substituted or unsubstituted (C₂-C₁₀) alkyl group.

23. (canceled)

24. The formulation of claim 1, wherein the amine-based corrosion inhibitor is present in an amount of from about 0.1 to about 5% by weight based on the total weight of the formulation.

25. The formulation of claim 1, wherein the organic solvent comprises at least one polar organic solvent selected from the group consisting of polyethylene glycol 3350, Agnique AMD3L, Rhodiasol PolarClean, dimethyl sulfoxide, sulfolane, propane-1,2,3-triol, xylenes, and mixtures thereof.

26. (canceled)

27. (canceled)

28. The formulation of claim 1, wherein the formulation exhibits a reduced corrosion behavior compared to nitrapyrin formulations that do not contain an amide-based corrosion inhibitor.

29. (canceled)

30. (canceled)

31. The formulation of claim 1, wherein the nitrapyrin complex is present in an amount of from about 1% to about 50% wt/wt based on the total weight of the formulation.

32. (canceled)

33. (canceled)

34. The formulation of claim 1, wherein the formulation containing nitrapyrin complexed with a polyanion reduces the volatility of the nitrapyrin from about 30% to about 90% compared to formulations that do not contain nitrapyrin complexed with a polyanion.

35. A composition comprising an agricultural product and the noncorrosive nitrapyrin formulation of claim 1, wherein the agricultural product is selected from the group consisting of fertilizer, seed, urease-inhibiting compound, nitrification inhibiting compound, and a biocide.

36. (canceled)

37. (canceled)

38. (canceled)

39. A method of fertilizing soil and/or improving plant growth and/or health comprising contacting a formulation of claim 1 molto the soil.

40. The method of claim 39, wherein the formulation is applied to the soil prior to emergence of a planted crop.

41. The method claim 39, wherein the formulation is applied to soil adjacent to a plant, at the base of the plant, or in the root zone of the plant.

42. The method of claim 39, wherein the plant is selected from the group consisting of: cereal, wheat, barley, oat, triticale, rye, rice, maize, soya beans, potato, vegetable, peanuts, cotton, oilseed rape and fruit plant.

43. (canceled)

44. (canceled)

45. (canceled)

46. (canceled)

47. (canceled)
